(19) United States
(12) Patent Application Publication
(10) Pub. No.: US 2026/0046212 A1
(43) Pub. Date: Feb. 12, 2026

(54) METHOD AND APPARATUS FOR NWDAF-BASED QOS SERVICE EXPERIENCE AND QOS FLOW LEVEL ANALYTICS IN A WIRELESS COMMUNICATION SYSTEM

(71) Applicant: Samsung Electronics Co., Ltd., Gyeonggi-do (KR)

(72) Inventors: Tingyu XIN, Middlesex (GB); Jonas SEDIN, Middlesex (GB)

(21) Appl. No.: 19/293,457

(22) Filed: Aug. 7, 2025

(30) Foreign Application Priority Data
Aug. 7, 2024 (GB) 2411648.5
Jul. 9, 2025 (GB) 2511109.7

(51) Int. Cl. H04L 41/14; H04L 41/5067; H04W 28/02

(52) U.S. Cl. CPC H04L 41/14; H04L 41/5067; H04W 28/0257; H04W 28/0268

(57) ABSTRACT

The disclosure relates to a 5G or 6G communication system for supporting a higher data transmission rate. According to an example of the present disclosure, a method performed by an NWDAF entity in a wireless communication system, the method comprising: receiving, from a PCF entity, a first message requesting analytics of QoS and policy assistance, wherein the first message includes at least one QoS parameter set; and transmitting, to the PCF entity, a second message including the analytics. The analytics include predictions on the QoS and policy assistance associated with the at least one QoS parameter set, and QoS parameters or a policy to apply for a service are based on the analytics.

### CROSS REFERENCE TO RELATED APPLICATION(S)

This application is based on and claims priority under 35 U.S.C. § 119(a) to United Kingdom Patent Application Nos. 2411648.5 and 2511109.7, which were filed in the United Kingdom Intellectual Property Office on Aug. 7, 2024, and Jul. 9, 2025, respectively, the entire disclosure of which is incorporated herein by reference.

### BACKGROUND

### 1. Field

The disclosure relates generally to the field of wireless communication, and more particularly, to a terminal and a communication method thereof in a wireless communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

It is an aim of certain examples of the present disclosure to address, solve and/or mitigate, at least partly, at least one of the problems and/or disadvantages associated with the related art, for example at least one of the problems and/or disadvantages described herein.

It is an aim of certain examples of the present disclosure to provide at least one advantage over the related art, for example at least one of the advantages described herein. According to an aspect of the present disclosure, there is provided a policy control function (PCF) entity configured to request or subscribe to analytics relating to quality of service (QoS) from an network data analytics function (NWDAF) entity; and receive, from the NWDAF entity, analytics results relating to QoS and comprising service experience information associated with one or more candidate QoS parameter set. The request or subscription indicates one or more QoS parameter set. Each QoS parameter set includes at least one parameter and, for each of the at least one parameter, a value for the parameter. The at least one parameter includes at least one of a 5G QoS identifier (5QI), one or more QoS characteristics, a guaranteed flow bit rate (GFBR), or a maximum flow bit rate (MFBR).

According to various examples, the PCF entity is configured to, based on the analytics results, determine a new policy or QoS for a UE, or based on the analytics results, modify an existing policy or QoS for the UE.

According to various examples, the request or subscription further indicates a quality of experience (QoE), and the one or more candidate QoS parameter set satisfies the indicated QoE.

According to various examples, the analytics results include one or more QoE associated with the one or more candidate QoS parameter set.

According to various examples, the request or subscription further indicates one or more of a preferred order of results for the one or more candidate QoS parameter, or an ordering criterion for one or more QoE associated to the one or more candidate QoS parameter set.

According to various examples, the request or subscription is transmitted to the NWDAF entity via another entity.

According to various examples, the analytics results comprise a duration of a time slot, and/or the service experience information includes an indication of the one or more candidate QoS parameter set.

According to various examples, the service experience information includes, for each of the one or more candidate QoS parameter set, one or more of a data network name (DNN) for a protocol data unit (PDU) session that includes a corresponding QoS flow for the candidate QoS parameter set; a list of radio access technology (RAT) type(s) for which the information applies; a QoE associated with the candidate QoS parameter set; value(s) of individual parameter(s) in the candidate QoS parameter set; a validity period within the time slot for the analytics results; an area where the analytics results apply; or a valid duration of a corresponding QoS and/or a valid duration of the service experience information.

According to various examples, the value(s) of individual parameter(s) for each of the one or more candidate QoS parameter set correspond to one or more of: a priority level; a packet delay budget (PDB); a packet error rate (PER); an averaging window; or a maximum delay burst volume.

According to various examples, the PCF entity is configured to, if the PCF entity subscribes to the analytics relating to QoS, receive new analytics results relating to QoS from the NWDAF entity.

According to various examples, the one or more QoS parameter sets and the one or more candidate QoS parameter set include the same parameter(s).

According to another aspect of the present disclosure, there is provided an NWDAF entity configured to receive, from a PCF entity, a request or subscription to analytics relating to QoS; and provide, to the PCF entity, analytics results relating to QoS and comprising service experience information associated with one or more candidate QoS parameter set. The request or subscription indicates one or more QoS parameter set. Each QoS parameter set includes at least one parameter and, for each of the at least one parameter, a value for the parameter. The at least one parameter includes at least one of a 5QI, one or more QoS characteristics, a GFBR, or an MFBR.

According to various examples, the NWDAF entity is configured to obtain data from one or more entity in a network, and derive the analytics results based on the obtained data.

According to various examples, the obtained data includes at least one of a packet filter set obtained from a session management function (SMF) entity; a UE location obtained from an access and mobility management function (AMF) entity or a gateway mobile location centre (GMLC) entity; a time stamp associated with data obtained from an SMF entity; service data obtained from an operations, administration and maintenance (OAM) entity; a RAT type camped on by a UE or accessed by the UE, obtained from an SMF entity; delay between a user plane function (UPF) entity and radio access network (RAN) entity, obtained from an OAM entity; and uplink (UL)/downlink (DL) delay between a UE and RAN, obtained from an OAM entity.

According to various examples, the analytics results include a duration of a time slot, and/or the service experience information includes an indication of the one or more candidate QoS parameter set.

According to various examples, the service experience information includes, for each of the one or more candidate QoS parameter set, one or more of a DNN for a PDU session that includes a corresponding QoS flow for the candidate QoS parameter set; a list of RAT type(s) for which the information applies; a QoE associated with the candidate QoS parameter set; value(s) of individual parameter(s) in the candidate QoS parameter set; a time window or time slot associated to the information; a validity period within the time slot for the analytics results; an area where the analytics results apply; or a valid duration of a corresponding QoS and/or a valid duration of the service experience information.

According to various examples, the value(s) of individual parameter(s) for each of the one or more candidate QoS parameter set correspond to one or more of a priority level; a PDB; a PER; an averaging window; or a maximum delay burst volume.

According to various examples, the request or subscription further indicates a QoE, and a predicted QoE of the one or more candidate QoS parameter set satisfies the indicated QoE.

According to various examples, the request or subscription further indicates one or more of a preferred order of results for the one or more candidate QoS parameter, or an ordering criterion for one or more QoE associated to the one or more candidate QoS parameter set.

According to various examples, the request or subscription is received via another entity.

According to various examples, the NWDAF entity is configured to, if the PCF entity has subscribed to the analytics relating to QoS, generate new analytics results relating to QoS and provide the new analytics results to the PCF entity.

According to various examples, the one or more QoS parameter sets and the one or more candidate QoS parameter set include the same parameter(s).

According to another aspect of the present disclosure, there is provided a method of (or for) a PCF entity. The method includes requesting or subscribing to analytics relating to QoS from an NWDAF entity; and receiving, from the NWDAF entity, analytics results relating to QoS and including service experience information including one or more candidate QoS parameter set. The request or subscription indicates one or more QoS parameter set. Each QoS parameter set includes at least one parameter and, for each of the at least one parameter, a value for the parameter. The at least one parameter includes at least one of a 5QI, one or more QoS characteristics, a GFBR, or an MFBR.

According to various examples, the method of/for the PCF entity includes operation(s) and/or feature(s) in accordance with any of the examples relating to the PCF entity given above.

According to another aspect of the present disclosure, there is provided a method of (or for) an NWDAF entity. The method includes receiving, from a PCF entity, a request or subscription to analytics relating to QoS; and providing, to the PCF entity, analytics results relating to QoS and including service experience information comprising one or more candidate QoS parameter set. The request or subscription indicates one or more QoS parameter set. Each QoS parameter set includes at least one parameter and, for each of the at least one parameter, a value for the parameter. The at least one parameter includes at least one of a 5QI, one or more QoS characteristics, a GFBR, or an MFBR.

According to various examples, the method of/for the NWDAF entity includes operation(s) and/or feature(s) in accordance with any of the examples relating to the NWDAF entity given above.

According to another aspect of the present disclosure, there is provided a computer-readable storage medium comprising instructions which, when executed by at least one processor of an electronic device (e.g., a computer), cause the electronic device to perform a method according to any one of the aspects or examples described above.

Other aspects, advantages and salient features of the invention will become apparent to those skilled in the art from the following detailed description taken in conjunction with the accompanying drawings.

### BRIEF DESCRIPTION OF THE DRAWINGS

The above and other aspects, features and advantages of certain embodiments of the present disclosure will be more apparent from the following description taken in conjunction with the accompanying drawings, in which:

FIG. 1 illustrates an association of QoS rules/policy and applied time window according to an embodiment;

FIG. 2 illustrates a procedure for candidate QoS analytics according to an embodiment;

FIG. 3 illustrates a network entity according to an embodiment;

FIG. 4 is a flow diagram illustrating a method of a PCF entity according to an embodiment;

FIG. 5 is a flow diagram illustrating a method of an NWDAF entity according to an embodiment;

FIG. 6 illustrates a terminal or UE according to an embodiment;

FIG. 7 illustrates a base station (BS) according to an embodiment; and

FIG. 8 illustrates a network entity according to an embodiment.

### DETAILED DESCRIPTION

Hereinafter, various embodiments of the disclosure will be described in detail with reference to the accompanying drawings.

In describing the embodiments, descriptions related to technical contents well-known in the art and not associated directly with the disclosure will be omitted. Such an omission of unnecessary descriptions is intended to prevent obscuring the main idea of the disclosure and more clearly transfer the main idea.

For similar reasoning, in the accompanying drawings, some elements may be exaggerated, omitted, or schematically illustrated. Further, the size of each element does not completely reflect the actual size. In the drawings, identical or corresponding elements may be provided with identical reference numerals or different reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various forms. The following embodiments are provided only to completely disclose the disclosure and inform those skilled in the art of the scope of the disclosure, and the disclosure is defined only by the scope of the appended claims.

Furthermore, in describing the disclosure, a detailed description of known functions or constitution incorporated herein will be omitted in the case that it is determined that the description may make the subject matter of the disclosure unnecessarily unclear. The terms which will be described below are terms defined in consideration of the functions in the disclosure, and may be different according to users, intentions of the operators, or customs. Therefore, the definitions of the terms should be made based on the contents throughout the specification.

Herein, each block of the flowchart illustrations, and combinations of blocks in the flowchart illustrations, may be performed based on computer program instructions. These computer program instructions may be loaded collectively onto at least one processor of a general purpose computer, special purpose computer, or other programmable data processing apparatus to produce a machine, such that the instructions, which perform through any one of, or in any combination of, the at least one processor of the computer or other programmable data processing apparatus, create means for performing the functions specified in the flowchart block(s). These computer program instructions may also be stored in a non-transitory computer usable or computer-readable memory that may direct a computer or other programmable data processing apparatus to function in a particular manner, such that the instructions stored in the computer usable or computer-readable memory produce an article of manufacture including instruction means that perform the function specified in the flowchart block(s). The computer program instructions may also be loaded onto a computer or other programmable data processing apparatus to cause a series of operational steps to be performed on the computer or other programmable data processing apparatus to produce a computer executed process such that the instructions that perform on the computer or other programmable data processing apparatus provide steps for executing the functions specified in the flowchart block(s). The entirety of the one or more computer program instructions may be stored in a single memory device or the one or more computer programs may be divided with different portions stored in different multiple memory devices.

Further, each block may represent a module, segment, or portion of code, which includes one or more executable instructions for executing the specified logical function(s). In some alternative implementations, the functions noted in the blocks may occur out of the order. For example, two blocks (or functions) shown in succession may in fact be performed substantially concurrently or the blocks may sometimes be performed in the reverse order, depending upon the functionality involved.

Herein, a “˜unit” may refer to a software element or a hardware element, such as a field programmable gate array (FPGA) or an application specific integrated circuit (ASIC), which performs a predetermined function. However, the term including the word “˜unit” does not always have a meaning limited to software or hardware. The “˜unit” may be constructed either to be stored in an addressable storage medium or to execute one or more processors. Therefore, the “˜unit” includes, for example, software elements, object-oriented software elements, components such as class elements and task elements, processes, functions, properties, procedures, sub-routines, segments of a program code, drivers, firmware, micro-codes, circuits, data, database, data structures, tables, arrays, and parameters. The components and functions provided by the “˜unit” may be either combined into a smaller number of components and a “˜unit,” or divided into additional components and a “˜unit.” Moreover, the components and “˜units” may be implemented to reproduce one or more central processing units (CPUs) within a device or a security multimedia card. Further, in the embodiments, the “˜unit” may include one or more processors.

Any of the functions or operations described herein can be processed by one processor or a combination of processors. The one processor or the combination of processors is circuitry performing processing and includes circuitry like an application processor (AP), e.g., a CPU, a communication processor (CP), e.g., a modem, a graphics processing unit (GPU), a neural processing unit (NPU) (e.g., an AI chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, etc.

Various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or ICs or on an optically or magnetically readable medium such as, for example, a compact disc (CD), digital versatile disc (DVD), magnetic disk, magnetic tape, etc. The storage devices and storage media are various embodiments of non-transitory machine-readable storage that are suitable for storing a computer program or computer programs comprising instructions that, when executed, implement various embodiments of the disclosure. Accordingly, various embodiments of the present disclosure may provide a program comprising code for implementing apparatus or a method as claimed in any one of the claims of this specification and a non-transitory machine-readable storage storing such a program.

Hereinafter, the determination of priority between A and B in the present disclosure may refer to various actions such as selecting the one having a higher priority based on a predefined priority rule and performing an operation corresponding thereto, or omitting or dropping an operation corresponding to the one having a lower priority.

Hereinafter, “A or B” as described in the present disclosure may be understood as “A and/or B,” which may include A, or B, or both A and B.

In addition, “at least one of A, B, and C” as described in the present disclosure may be understood to include A, B, or C, or any combination of A, B, and C.

In addition, “at least one of A, B, or C” as described in the present disclosure may be understood to include A, B, or C, or any combination of A, B, and C.

Furthermore, “A/B” as described in the present disclosure may be understood as “A and/or B,” which may include A, B, or both A and B.

Furthermore, “A, B” as described in the present disclosure may be understood as “A and/or B,” which may include A, B, or both A and B.

Furthermore, “A and B” as described in the present disclosure may be understood as “A and/or B,” which may include A, B, or both A and B.

Furthermore, “if condition A and condition B are satisfied,” as described in the present disclosure, may not be limited to a case where both condition A and condition B are satisfied, but may be understood to include a case where either condition A or condition B is individually satisfied, both condition A and condition B are satisfied, or one or more additional conditions are satisfied in combination.

Furthermore, throughout this disclosure, ordinal terms such as “first,” “second,” “third,” etc., (and similar qualifiers) are used to distinguish between different instances, occurrences, configurations, messages, stages, or aspects of elements, operations, or information as described herein. Unless the context clearly dictates otherwise, the use of such ordinal terms does not itself require that the elements, operations, or information distinguished by these terms be structurally different, numerically distinct, or substantively dissimilar. For example, a “first signal and a “second signal” may refer to instances of the same signal transmitted at different times or containing the same core information despite minor variations, or they may refer to signals with different content or characteristics, depending on the specific context. Similarly, a “first value” and a “second value” may represent the same magnitude but measured or applied in different circumstances, or they may represent different magnitudes. The interpretation should be guided by the specific technical context, function, and relationship described in the relevant portion of the specification and claims.

Furthermore, the terms “first ˜”, “second ˜”, etc., as described in the present disclosure with respect to various elements (e.g., information, objects, operation, sequences, or the like), should not limit those elements. These terms may only be intended to distinguish one element from another, and may not be intended to indicate a specific order. For example, a first element could be termed a second element, and, similarly, a second element could be termed a first element.

Furthermore, even if “first ˜” and “second ˜” are described in the present disclosure, it may be understood that element(s) referred to by “first ˜” and “second ˜” may be the same or different. For example, in case of element(s) being information, first information and second information may both be same information and, in some cases, are separate and different information.

In addition, the terms “if ˜” and “in case that ˜” as used in the disclosure or claims may be interpreted to include the meanings of “when (or upon) ˜,” “in response to ˜,” “based on ˜,” or “according to ˜,” and may be used interchangeably with these expressions. In addition, expressions other than those exemplified herein may also be used, as long as they have substantially the same meaning and do not impair the technical features of the present disclosure.

For example, the physical layer signaling may be referred to as layer 1 (L1) signaling and may include DL control information (DCI). In addition, the higher layer signaling may include a medium access control (MAC) control message, a radio resource control (RRC) signaling message, a non-access stratum (NAS) signaling message, or an application layer message. The RRC signaling message may be referred to as layer 3 (L3) signaling. However, the higher layer signaling is not limited to the aforementioned examples.

In addition, “transmitting a message including A and B” as described in the present disclosure, may be understood as encompassing both (i) transmitting A and B in a single message, and (ii) transmitting A and B separately via multiple messages (e.g., transmitting a first message including A and a second message including B). This interpretation may also apply to messages that include two or more items (e.g., A, B, C), transmitted either together or separately.

In addition, “transmitting a message including A and transmitting a message including B” may also be interpreted as transmitting a message including A and B in a single message.

In specific embodiments of the present disclosure described below, terms or components included in the disclosure may be expressed in singular or plural form depending on the specific embodiments presented. However, such singular or plural expressions are selected appropriately for convenience of description, and the present disclosure is not limited to a singular or plural number of components. A component expressed in the plural form may be implemented as a single component, and a component expressed in the singular form may be implemented as multiple components.

The drawings or flowcharts described below illustrate exemplary methods that may be implemented according to the principles of the present disclosure, and various modifications may be made to the methods illustrated in the flowcharts of the present disclosure. For example, although illustrated as a series of steps, various steps in each drawing or flowchart may overlap, occur in parallel, occur in a different order, or be repeated. In other examples, any step may be omitted or replaced with another step.

The methods and apparatuses proposed in the embodiments of the present disclosure are not limited to each embodiment individually, but may also be applied in combination of all or some of the embodiments proposed in the disclosure. Therefore, the embodiments of the present disclosure may be modified and applied without significantly departing from the scope of the present disclosure, as would be understood by those skilled in the art.

In this case, even if certain wordings are described differently across embodiments, they may be used interchangeably or in substitution or in combination if their underlying concepts are equivalent. For example, for the same or equivalent concept, even if one embodiment uses the expression “A” and another embodiment uses the expression “B”, such expressions may be understood interchangeably, in substitution, or in combination.

The terms used in the following description to refer to access nodes, network entities, messages, interfaces between network entities, various types of identification information, and the like, are provided merely for the convenience of explanation by way of example. Therefore, the present disclosure is not limited to the terms described below, and other terms having equivalent technical meanings may also be used. Such terms may also be interchangeable with terms defined in any 3rd generation partnership project (3GPP) technical specification (TS) where appropriate.

Hereinafter, a BS is an entity that allocates resources to terminals, and may be at least one of a gNode B, an eNode B, a Node B, a wireless access unit, a BS controller, or a node on a network.

Furthermore, the BS of the present disclosure may include a split architecture comprising a central unit (CU) and a distributed unit (DU). In this structure, the CU is configured to process the higher layers of the control and user planes, while the DU is configured to process lower-layer radio resource functions. The embodiments of the present disclosure may be equally applicable to 5G BS architectures in which such CU and DU functional splits are implemented.

A terminal may include a UE, a mobile station (MS), a cellular phone, a smartphone, a computer, or a multimedia system capable of performing communication functions.

In the disclosure, a DL refers to a radio link through which a BS transmits a signal to a UE, and a UL refers to a radio link through which a UE transmits a signal to a BS.

Furthermore, 5G mobile communication technologies (e.g., 5G NR) and 6G mobile communication technologies may be described by way of example, but the embodiments of the present disclosure may also be applied to other communication systems having similar technical backgrounds or channel types. For example, newly evolved mobile communication systems developed after 5G and 6G may be included. Furthermore, based on determinations by those skilled in the art, the embodiments of the present disclosure may also be applied to other communication systems (e.g., Wi-Fi systems) through some modifications without significantly departing from the scope of the present disclosure

In the following description, the terms physical channel and signal may be used interchangeably with data or control signal. For example, the term physical DL shared channel (PDSCH) refers to a physical channel through which data is transmitted, but the term PDSCH may also be used to refer to the data itself. That is, in the present disclosure, the expression “transmit a physical channel” may be interpreted as being equivalent to the expression “transmit data or a signal via a physical channel.”

Hereinafter, in the context of the present disclosure, higher layer signaling may refer to signaling corresponding to at least one or any combination of the following: master information block (MIB), system information block (SIB) or SIB M (M=1, 2, . . . ), RRC, or MAC control element (CE), or an NAS signaling message, or an application layer message. The RRC signaling message may be referred to as L3 signaling.

In addition, L1 signaling may refer to signaling corresponding to at least one or any combination of signaling techniques using the at least one or any combination of the following physical layer channels or signaling: physical DL control channel (PDCCH), DCI, UE-specific DCI, group-common DCI, common DCI, scheduling DCI (e.g., DCI used for scheduling DL or UL data), non-scheduling DCI (e.g., DCI not used for scheduling DL or UL data) physical UL control channel (PUCCH), or UL control information (UCI). The L1 signaling message may be referred to as a physical layer signaling.

Hereinafter, the expression that information is configured by the BS, as used in the present disclosure or claims, may, in context, be understood to mean that the terminal receives the corresponding information from the BS via a physical layer signaling or a higher layer signaling. Such an expression may be replaced with other terms having the same or substantially equivalent meaning.

### Overview of QoS and Policy and Charging Control (PCC) Rules

As defined in TS 23.501, the QoS parameters of a 5G system (5GS) include:
5QI: 5G QoS Identifier
Allocation and retention priority (ARP): priority level, the pre-emption capability and the pre-emption vulnerability.
Reflective QoS attribute (RQA): an optional parameter which indicates that certain traffic (not necessarily all) carried on this QoS Flow is subject to Reflective QoS
QoS Parameter Notification control: indicates whether notifications are requested from a next generation (NG)-RAN when the “GFBR can no longer (or can again) be guaranteed” for a QoS Flow during the lifetime of the QoS Flow. Notification control may be used for a GBR QoS Flow if the application traffic is able to adapt to the change in the QoS (e.g., if an application function (AF) is capable to trigger rate adaptation).
Flow Bit Rates
   GFBR—UL and DL;
   MFBR—UL and DL.
Aggregate Bit Rates:
   per session aggregate maximum bit rate (Session-AMBR): The Session-AMBR limits the aggregate bit rate that can be expected to be provided across all non-GBR QoS Flows for a specific PDU session
   per UE aggregate maximum bit rate (UE-AMBR): aggregate bit rate that can be expected to be provided across all non-GBR QoS Flows of a UE
   per UE per slice-maximum bit rate (UE-Slice-MBR): aggregate bit rate that can be expected to be provided across all GBR and non-GBR QoS Flows corresponding to PDU Sessions of the UE for the same slice (e.g., single network slice selection assistance (S-NSSAI)) which have an active user plane.
Default values: For each PDU Session Setup, the SMF retrieves the subscribed Session-AMBR values as well as the subscribed default values for the 5QI and the ARP and optionally, the 5QI priority level, from a unified data management (UDM). The subscribed default 5QI value shall be a non-GBR 5QI from the standardized value range.
Maximum Packet Loss Rate: maximum rate for lost packets of the QoS Flow that can be tolerated in the UL and DL direction. This is provided to the QoS Flow if it is compliant to the GFBR

Within a 5GS, a QoS flow associated with the default QoS rule should be established for a PDU Session and remains established throughout the lifetime of the PDU session. This QoS flow should be a non-GBR QoS flow.

For QoS rules, as defined in TS 23.501:

The UE performs the classification and marking of UL user plane traffic, i.e., the association of UL traffic to QoS flows, based on QoS rules. These QoS rules may be explicitly provided to the UE (i.e., explicitly signalled QoS rules using the PDU session establishment/modification procedure), pre-configured in the UE or implicitly derived by the UE by applying reflective QoS (see clause 5.7.5).

A QoS rule contains the QFI of the associated QoS flow, a packet filter set (see clause 5.7.6) and a precedence value (see clause 5.7.1.9). An explicitly signalled QoS rule contains a QoS rule identifier which is unique within the PDU Session and is generated by SMF.

There can be more than one QoS rule associated with the same QoS flow (i.e., with the same QFI).

A default QoS rule is required to be sent to the UE for every PDU session establishment and it is associated with a QoS Flow. For an IP type PDU session or an ethernet type PDU session, the default QoS rule is the only QoS rule of a PDU session that may contain a packet filter set that allows all UL packets, and in this case, the highest precedence value shall be used for the QoS rule.

For an unstructured type PDU session, the default QoS rule does not contain a packet filter set, and in this case, the default QoS rule defines the treatment of all packets in the PDU Session.

If the default QoS rule does not contain a Packet Filter Set or contains a packet filter set that allows all UL packets, reflective QoS should not be applied for the QoS flow that the default QoS rule is associated with and the RQA should not be sent for this QoS Flow.

The PCC rules/decision is defined in TS 23.503:

The QoS rules is generated by PCF and then provisioned to the SMF.

PCC decision: A PCF decision for policy and charging control provided to the SMF (e.g., including PCC rules and PDU session related attributes), a PCF decision for access and mobility related policy control provided to the AMF, a PCF decision for UE policy information provided to the UE or a PCF decision for service related policy (e.g., background data transfer policy) provided to the AF.

QoS control refers to the authorization and enforcement of the maximum QoS that is authorized for a service data flow, for a QoS Flow or for the PDU Session. A service data flow may be either of IP type or of ethernet type. PDU Sessions may be of IP type or Ethernet type or unstructured.

The authorized QoS for a service data flow template shall include a 5QI and the ARP and may include a 5QI priority level
For a 5QI of GBR or delay-critical GBR resource type, the authorized QoS shall also include the MBR and GBR, and may include the QoS Notification Control parameter (for notifications when authorized GFBR can no longer (or can again) be fulfilled).
For 5QI of non-GBR resource type, the authorized QoS may include the MBR and the reflective QoS control parameter
The 5QI value can be standardized (i.e., referring to QoS characteristics as defined in clause 5.7.3 of TS 23.501), pre-configured (i.e., referring to QoS characteristics configured in the RAN) or dynamically assigned

QoS control also refers to the authorization and enforcement of the session-AMBR, default 5QI/ARP combination and 5QI Priority Level, if applicable. The PCF may provide the authorized session-AMBR, the Authorized default 5QI and ARP combination and the 5QI priority level as part of the PDU session information for the PDU Session to the SMF. The authorized session-AMBR, authorized default 5QI/ARP, and if available, 5QI priority level values take precedence over other values locally configured or received at the SMF.

The PCC rules are determined by PCF. The PCF may take the information collected by multiple data sources to make the PCC decision, as specified in 6.2.1.2 of TS23.503:
The PCF shall accept input for PCC decision-making from the SMF, the AMF, the charging function (CHF), the NWDAF if present, a unified data repository (UDR) and if the AF is involved, from the AF, as well as the PCF may use its own predefined information
The AMF may provide information related to the UE as defined in clauses 5.2.5.2 and 5.2.5.6 of TS 23.502, for example in the following services:
   Npcf_AMPolicyControl service
   Npcf_UEPolicyControl Service
The SMF may provide information related to the PDU Session as defined in clause 5.2.5.4 of TS 23.502, for example: Default 5QI and default ARP, etc., and the parameters in the following services:
   Npcf_SMPolicyControl service of TS 23.502
   Npcf_SMPolicyControl_Create service operation:
      Inputs, Optional:-subscribed default QoS information
      Outputs, Optional: Policy information for the PDU Session as defined in TS 23.503 and Policy Control Request Trigger(s) of SM Policy Association as defined in clause 6.1.3.5 of TS 23.503.
   At PDU Session establishment, the NF Service Consumer, e.g., SMF, requests the creation of a corresponding SM Policy Association with the PCF (Npcf_SMPolicyControl_Create) and provides relevant parameters about the PDU Session to the PCF. When the PCF has created the SM Policy Association, the PCF may provide policy information for the PDU Session in the response.
The UDR may provide the information for a subscriber connecting to a specific DNN and S-NSSAI, as described in the clause 6.2.1.3.
The AF, if involved, may provide application session related information as defined in clause 5.2.5.3 of TS 23.502 directly or via a network exposure function (NEF), e.g., based on session initiation protocol (SIP) and SDP, for example: Npcf_PolicyAuthorization Service. This service is to authorise an AF request and to create policies as requested by the authorized AF for the PDU Session to which the AF session is bound.
The NWDAF, if involved, may provide analytics information as described in clause 6.1.1.3. Examples of operator policies including network analytics information as inputs for policy decisions included:
   Based on the “Service Experience” statistics or predictions, the PCF may check the 5QI values assigned to the application, and may use this as input to calculate and update the authorized QoS for a service data flow template.
   Based on the “User Data Congestion” statistics or predictions including the list of applications contributing the most to the traffic the PCF may perform SM policy association modifications to update policies in the SMF for the PDU sessions handling traffic from those applications.
   Examples of operator policies including combination of multiple network analytics as inputs for policy decisions are included: Based on the notification of application(s) in use, provided by “UE Communication” analytics, the PCF may request the “Service Experience” analytics (optionally per RAT Type and/or per Frequency) for each application in use as defined in the list of examples of operator policies that may include network analytics as input for a policy decision.
QoS flow descriptions in Clause 6.25 of TS 24.501:
2.5.1.1.4 QoS flow descriptions
The network can also provide the UE with one or more QoS flow descriptions associated with a PDU session at the PDU session establishment or at the PDU session modification.
Each QoS flow description contains:
   a) a QoS flow identifier (QFI);
   b) if the flow is a GBR QoS flow:
      1) GFBR for UL;
      2) GFBR for DL;
      3) MFBR for UL;
      4) MFBR for DL; and
      5) optionally averaging window, applicable for both UL and DL;
   c) 5QI, if the QFI is not the same as the 5QI of the QoS flow identified by the QFI; and
   d) optionally, an EPS bearer identity (EBI) if the QoS flow can be mapped to an EPS bearer as specified in subclause 4.11.1 of 3GPP TS 23.502 [9].
If the averaging window is not included in a QoS flow description for a GBR QoS flow with a 5QI indicated in 3GPP TS 23.501 table 5.7.4-1, the averaging window associated with the 5QI in 3GPP TS 23.501 table 5.7.4-1 applies for the averaging window.
If the averaging window is not included in a QoS flow description for a GBR QoS flow with a 5QI not indicated in 3GPP TS 23.501 table 5.7.4-1, the standardized value of two seconds is used as the averaging window.

### Overview of NWDAF Analytics to Support Policy Decision

As described above, when making PCC rules or other policy decisions, the PCF may consider the NWDAF analytics as input for decision making. The NWDAF analytics are defined in TS 23.288. As described above, UE Communication and Service Experience are two analytics used by the PCF to determine the QoS currently.

UE Communication Analytics is defined in clause 6.7.3 of TS 23.288, and was introduced to support some optimized operations, e.g., customized mobility management, traffic routing handling, radio frequency selection priority (RFSP) index management, QoS improvement or Inactivity Timer optimization, in 5GS, an NWDAF may perform data analytics on UE communication pattern and user plane traffic and provide the analytics results (i.e., UE communication statistics or prediction) to NFs in the 5GC or an AF. An NWDAF supporting UE Communication Analytics collects per-application communication description from AFs. If consumer NF provides an Application ID, the NWDAF only considers the data from AF, SMF and UPF that corresponds to this application ID. NWDAF may also collect data from AMF.

The output analytics (use predictions as examples) of the UE Communication Analytics are in Table 1 (Table 6.7.3.3-2: UE Communication Predictions of TS 23.822) The outputs include the per UE or per UE group parameters, and per application ID level parameters.

TABLE 1
Table 6.7.3.3-2: UE Communication Predictions of TS 23.822

| Information | Description |
|---|---|
| UE group ID or UE ID | Identifies a UE or a group of UEs, e.g., internal group ID |
| | defined in clause 5.9.7 of TS 23.501 or SUPI (see NOTE). |
| UE communications (1 . . . max) | List of communication time slots. |
| (NOTE 1) | |
| > Periodic communication | Identifies whether the UE communicates periodically or |
| indicator (NOTE 1) | not. |
| > Periodic time (NOTE 1) | Interval Time of periodic communication (average and |
| | variance) if periodic. |
| | Example: every hour. |
| > Start time (NOTE 1) | Start time predicted (average and variance). |
| > Duration time (NOTE 1) | Duration interval time of communication. |
| > Traffic characterization | S-NSSAI, DNN, ports, other useful information. |
| > Traffic volume (NOTE 1) | Volume UL/DL (average and variance). |
| > Confidence | Confidence of the prediction. |
| > Ratio | Percentage of UEs in the group (in the case of a UE group). |
| Applications (0 . . . max) | List of application in use. |
| (NOTE 1) | |
| > Application Id | Identification of the application. |
| > Start time | Start time of the application. |
| > Duration time | Duration interval time of the application. |
| > Occurrence probability | Probability the application will be used by the UE. |
| > Spatial validity | Area where the service behaviour applies. If Area of |
| | Interest information was provided in the request or |
| | subscription, spatial validity may be a subset of the |
| | requested Area of Interest. If a Spatial granularity size was |
| | provided in the request or subscription, the number of |
| | elements of TAs or cells in the area is smaller than or equal |
| | to the Spatial granularity size. |
| N4 Session ID (1 . . . max) | Identification of N4 Session. |
| (NOTE 1) (NOTE 2) | |
| > Inactivity detection time | Value of session inactivity timer (average and variance). |
| > Confidence | Confidence of the prediction. |

NOTE 1:
Analytics subset that can be used in “list of analytics subsets that are requested” and “Preferred level of accuracy per analytics subset”.
NOTE 2:
This analytics subset shall only be included if the consumer is SMF.

The Observed Service Experience related network data analytics is specified in clause 6.4 of TS 23.288. the Observed Service Experience can provide the analytics of user experience, i.e., average of observed service mean opinion score (MOS) and/or variance of observed Service MoS indicating service MOS distribution for services such as audio-visual streaming as well as services that are not audio-visual streaming such as V2X and Web Browsing services, analytics, in the form of statistics or predictions, to a service consumer. These analytics may collected huge amount of data from different sources and at different levels. And the output analytics can be for an application, an network slice and an UE. The outputs of these analytics are in (use statistics as examples).

TABLE 2
Table 6.4.3-1: Service Experience statistics of TS 23.288

| Information | Description |
|---|---|
| Slice instance service | List of observed service experience information for each Network |
| experiences (0 . . . max) | Slice instance. |
| > S-NSSAI | Identifies the Network Slice |
| > NSI ID (NOTE 2) | Identifies the Network Slice instance within the Network Slice. |
| > Network Slice | Service experience across Applications on a Network Slice instance |
| instance service | over the Analytics target period (average, variance). |
| experience | |
| > SUPI list | List of SUPI(s) for which the slice instance service experience |
| (0 . . . SUPImax) | applies. |
| (NOTE 3) | |
| > Ratio (NOTE 3) | Estimated percentage of UEs with similar service experience (in the |
| | group, or among all UEs). |
| > Spatial validity | Area where the Network Slice service experience analytics applies. |
| (NOTE 6) | |
| > Validity period | Validity period for the Network Slice service experience analytics |
| | as defined in clause 6.1.3. |
| Application service | List of observed service experience information for each |
| experiences (0 . . . max) | Application. |
| > S-NSSAI | Identifies the Network Slice used to access the Application. |
| > Application ID | Identification of the Application. |
| > Service Experience | Type of Service Experience analytics, e.g., on voice, video, other. |
| Type | |
| > UE location | Indicating the UE location information (e.g., TAI list, gNB ID, or |
| (NOTE 1, NOTE 5) | location coordinates, etc) when the UE service is delivered. |
| > UPF Info (NOTE 4) | Indicating UPF serving the UE. |
| > DNAI | Indicating which DNAI the UE service uses/camps on. |
| > DNN | DNN for the PDU Session which contains the QoS flow. |
| > Application Server | Identifies the Application Server Instance (IP address of the |
| Instance Address | Application Server) or fully qualified domain name (FQDN) of |
| | Application Server. |
| > Service Experience | Service Experience over the Analytics target period (average, |
| | variance). |
| > SUPI list | List of SUPI(s) with the same application service experience. |
| (0 . . . SUPImax) | |
| (NOTE 3) | |
| > Ratio (NOTE 3) | Estimated percentage of UEs with similar service experience (in the |
| | group, or among all UEs). |
| > Spatial validity | Area where the Application service experience analytics applies. |
| (NOTE 6) | |
| > Validity period | Validity period for the Application service experience analytics as |
| | defined in clause 6.1.3. |
| > RAT Type | Indicating the list of RAT type(s) for which the application service |
| (NOTE 7) | experience analytics applies. |
| > Frequency | Indicating the list of carrier frequency values(s) of UE's serving |
| (NOTE 7) | cell(s) where the application service experience analytics applies. |
| > SSC Mode | SSC Mode selected for the PDU Session used to associate with the |
| | application. |
| > PDU Session Type | Type of PDU Session used to associate with the application. |
| > Access Type | List of Access Type(s) used for the PDU Session for the |
| | application. |

NOTE 1:
This information element is an Analytics subset that can be used in “list of analytics subsets that are requested” and “Preferred level of accuracy per analytics subset”.
NOTE 2:
The NSI ID is an optional parameter. If not provided the Slice instance service experience indicates the service experience for the S-NSSAI.
NOTE 3:
The SUPI list and Ratio in the service experience information for an application can be omitted, if the corresponding parameter(s) is/are provided and are assigned with the same value(s) in the service experience information for the slice instance which the application belongs to. Otherwise, the SUPI list and Ratio are mandatory to be provided for an application service experience.
NOTE 4:
If the consumer NF is an AF, the “UPF info” shall not be included.
NOTE 5:
When possible and applicable to the access type, UE location is provided according to the preferred granularity of location information. UE location shall only be included if the Consumer analytics request is for single UE or a list of UEs. Inclusion of UE location requires user consent.
NOTE 6:
The Spatial validity is present in the output parameters if the consumer provided the Area of Interest as defined in Table 6.4.1-1.
NOTE 7:
When “any” value has been provided in the request (e.g., “any” RAT type, “any” frequency, or “any” for all the RAT type and frequency indication), the NWDAF provides an instance of the Application service experience per combination of RAT Type(s) and/or Frequency value(s) having the same Service Experience.

### Overview of Standard

SA2 Rel-19 New SID on Core Network Enhanced Support for AI/ML was approved in SP-231800 during SA 102 meeting (December 2023). As it has been documented in the WT #3.1 in SP-231800:
WT3: Study enhancements to support NWDAF-assisted policy control and address network abnormal behaviour
WT3.1-Study whether and what additionally needs to be supported in order to enhance 5GC NF operations (i.e., policy control and QoS) assisted by NWDAF. The work will firstly identify the specific use cases to be considered, in order to identify the appropriate scope. The work will analyse the result impacts on NWDAF (e.g., the need to understand specific NF functionality), and the compatibility of new solutions wrt existing analytics, in order to determine the need and benefits of new solutions.

The Key issue description of WT3.1 was agreed and documented during SA2 160 ahe meeting. As documented in clause 5.2.3 of TR 23.700-84, Key Issue #3: NWDAF-assisted policy control and QoS enhancement:
The NWDAF can gather quite a lot of data from 5GC NFs, AF and OAM and thus may further assist the PCF in making PCC decisions (which traditionally determine QoS parameters based on its own data and knowledge as well optional statistics and predictions collected from the NWDAF).
This Key issue aims to study whether and what additionally needs to be supported in order to enhance 5GC NF operations related to policy control and QoS with the assistance of the NWDAF.
In this key issue, the following aspects will be studied:
Identification of use cases where policy control and QoS can be further enhanced with assistance from NWDAF.
   Whether and how to introduce new 5GC functionality, e.g., of the NWDAF and/or PCF to enhance the policy control and QoS, considering operator's policies.
   Whether and what additional input information is needed by the NWDAF for providing an assistance to policy control and QoS, and how to gather it.
   Whether and what output information, on top of already provided, the NWDAF can provide to assist with policy control and QoS enhancements.
   Whether and how to evaluate the quality of the enhanced NWDAF assistance to policy control and QoS.
NOTE 1: The study will focus primarily on existing enforcement mechanisms when available and identify new ones only when no existing ones can be used.

A use case associated to the above KI #3 was agreed in SA2 160 ahe meeting, and documented in 5.1.1, 5.1.2 of TR 23.700-84.

### Use Case #1: NWDAF-Assisted QoS Enhancement

Currently, the QoS parameters are determined by the PCF based on its knowledge, e.g., AF requirements, analytics provided by the NWDAF, etc. After applying the determined QoS parameters to the service, the PCF may determine whether or not the current QoS can fully satisfy the service requirements based on the Service Experience analytics provided by the NWDAF. If the current QoS cannot satisfy the service requirements, the PCF may update the QoS parameters and informs the new parameters to SMF. Then the PCF may require new Service Experience analytics to check whether the updated QoS parameters can satisfy the service requirements. Based on this current framework, it may require several iterations to work out the ideal QoS parameters. Using its knowledge based on data collection, NWDAF can assist the PCF in determining QoS parameters that can achieve the expected service experience requirements.
   Use Case #2: Enhancements to QoS Determination with NWDAF Assistance
A use case is provided for how the network can benefit from the NWDAF-assistance for QoS determination and setup for the purpose of optimising the overall network performance and signalling based on operator's policy.
After UE registers with the 5GS, a PDU session set up might be required. Each PDU session is associated with a default QoS rule which provides a default QoS treatment for data flows. Currently the characteristics of the default QoS is determined by the subscribed default values (for parameters such as 5QI, ARP) which the SMF may obtain from the UDM. The default QoS rule might be sufficient for basic browsing or instant messaging over IP, whereas it may not able to satisfy the relatively high service requirements, i.e., of video streaming applications which require better QoS treatment. For example, for V2X and XRM services, the applications may require transmitting traffic with Guaranteed Bit Rate (GBR) or to use certain standardised 5QI values even for non-GBR QoS flows. Therefore, the default QoS requirements may not be able to support such applications.
When the QoS flows with different requirements from the default flow are required, modification to the PDU session and thereby to establish a new QoS flow with the required characteristics might be needed. Such modification will result in significant system-wide signalling, including NAS signalling messages between the UE and the 5GC, signalling within 5GC (i.e., signalling between SMF, UPF, PCF), signalling between 5GC and RAN, and also the RRC messages between the RAN and the UE, etc. In order to optimise the network performance by determining QoS in a more intelligent manner, it would be beneficial for the 5GC to leverage NWDAF assistance. For example, when the UE or network trigger PDU session establishment or modification for a new QoS flow with QoS requirements driven by a user or service, it would be beneficial if the QoS characteristics are determined by the network by considering the predictions and measurements of some UE and network related information and also service related information (e.g., service requirements provided by the AF). The information considered by the 5GC could be some patterns in terms of frequency of use of one or more services and the potential QoS requirements to be emerged from the UE subsequently, the QoS sustainability of the UE or of an area the UE belongs to, the corresponding UE locations, the service requirements provided by the AF, etc. Therefore, the PDU session and QoS flow can be established or modified in a more ‘future proof’ and multiple-service-compatible manner and reduce the potential modifications of the existing QoS flow and the corresponding policy control, e.g., PCC rules.
Based on this use case, potential enhancements to 5GC functionality e.g., of the NWDAF, PCF, to enhance the policy control and QoS by considering operator's policies, will improve the network performance and UE experience significantly.

Multiple solutions on Key Issue #3: NWDAF-assisted policy control and QoS enhancement was documented in TR 23.700-84.

In SA2 #163 meeting (May 2024), conclusions for Key Issue #3: NWDAF-assisted policy control and QoS enhancement were agreed and documented in clause 8.3 of TR 23.700-84, including
Based on PCF request, NWDAF may provide assistance information analytics to PCF to assist the QoS determination and/or modification of QoS parameters. The PCF may take the assistance information into account to determine QoS parameters for a QoS flow, based on the operator's policy.
After the PCF determines the QoS parameters, if updated assistance information is received from NWDAF (the updated assistance information may include candidate QoS parameters, the analytics of the duration and usage of established QoS Flows), the PCF may determine to modify the QoS parameters for a QoS flow and provide the modified QoS towards the SMF, based on the operator's policy.
In particular:
   The PCF may send a analytics request or subscription to NWDAF for QoS and policy assistance information analytics. The PCF may include an analytics ID, Filter Information, one or multiple sets of QoS parameters, the candidate value list(s) for each QoS parameter, requesting expected service experience (e.g., QoE), etc.
NOTE 1: Details of the input parameters in the PCF request will be determined in normative stage.
NOTE 2: Whether to introduce a new analytics ID or reuse existing one will be determined in normative stage.
   Based on the PCF request, the QoS and policy assistance information analytics provided by NWDAF may include: expected QoE can be achieved by the candidate QoS parameters (the values of the QoS parameters are within the candidate value list provided by the PCF).
NOTE 3: Whether the time window(s) associated with QoS parameters can be provided by PCF and can be then used to determine the candidate QoS will be discussed in the normative work.
NOTE 4: Whether to introduce new or reuse existing service/service operation for providing candidate QoS will be determined in normative phase.
   The PCF may request one or more analytics from the NWDAF that are used within the same analytics target period, i.e., Observed service experience, QoS sustainability, Network Performance analytics, analytics of the duration and usage of the established QoS Flows.
NOTE 5: Possible enhancements to the existing analytics and/or introducing new analytics will be determined in the normative phase.
NOTE 6 Details of the input data and corresponding data sources for analytics will be determined in normative stage.
NOTE 7: To provide the assistance for policy control and QoS, NWDAF shall not be aware of PCF internal logic.
NOTE 8: NWDAF can monitor the accuracy performance of the assistance information analytics based on a request from PCF. Whether to reuse the existing procedures for Analytics Accuracy Monitoring (defined in clause 6.2D of TS 23.288 [5]) or not can be decided in the normative phase.

### Overview of QoS Flow Analytics in TR 23.288-84

In clause 6.28 Solution #28: QoS Flow Analytics, it is documented to leverage the NWDAF by introducing more inputs and outputs to support the PCF policy determination.

The inputs of the NWDAF for QoS Flow Analytics include:

TABLE 6.28.2-1 of TR 23.700-84: Input data from 5GC related to QoS Flow

| Information | Source | Description |
|---|---|---|
| Time | SMF | Time stamp of the generated data record |
| UE ID | SMF, AF | SUPI in the case of SMF, external UE ID |
| | | (i.e., GPSI) in the case of AF |
| Group ID | SMF, AF | To identify UE group if available |
| | | Internal Group ID in the case of SMF, |
| | | External Group ID in the case of AF |
| S-NSSAI | SMF | Information to identify a Network Slice |
| DNN | SMF | Data Network Name where PDU connectivity |
| | | service is provided |
| Application ID | SMF, AF | Identifying the application providing |
| | | this information |
| PDU session ID (1 . . . max) | SMF | Identification of PDU Session. |
| >QoS Flow ID (1 . . . max) | | Identification of QoS Flow. |
| >>QoS profile | | AN QoS profile of the QoS Flow |
| >>QoS rules (1 . . . max) | | UE side QoS rules of the QoS Flow |
| >>>5QI | | 5QI associated to the QoS Rule |
| >>>QoS Parameters | | QoS parameters of the QoS Rule |
| UE locations (1 . . . max) | AMF | UE positions |
| >UE location | | TA or cells that the UE enters |
| >Timestamp | | A time stamp when the AMF detects the |
| | | UE enters this location |
| “Service data flow | PCF | The information of the traffic and |
| detection” and “Policy | | corresponding policy rules provided by |
| control” part of PCC rules | | the PCF. |

The outputs of the NWDAF for QoS Flow Analytics include:
NWDAF provides the statistic and prediction of QoS Flow as depicted in Table 6.28.2-2 and 6.28.3-3 respectively.

TABLE 6.28.2-2 of TR 23.700-84: Output statistics of QoS Flow Analytics

| Information | Description |
|---|---|
| UE ID | SUPI in the case of SMF, external UE ID |
| | (i.e., GPSI) in the case of AF |
| S-NSSAI | Information to identify a Network Slice |
| DNN | Data Network Name where PDU connectivity |
| | service is provided |
| Application ID | Identifying the application |
| QoS Flow (1 . . . max) | List of QoS Flows |
| >Duration | Duration of QoS Flow |
| >Number of usages | The number of times that this QoS Flow |
| | characteristics are used |
| >QoS profile | AN QoS profile of the QoS Flow |
| >QoS rules (1 . . . max) | UE side QoS rules of the QoS Flow |
| >>5QI | 5QI associated to the QoS Rule |
| >>QoS Parameters | QoS parameters of the QoS Rule |
| >“Service data flow | Traffic description and applied PCC rules |
| detection” and “Policy | |
| control” part of PCC rules | |

TABLE 6.28.2-2 TR 23.700-84: Output predictions of QoS Flow Analytics

| Information | Description |
|---|---|
| UE ID | SUPI in the case of SMF, external UE ID |
| | (i.e., GPSI) in the case of AF |
| S-NSSAI | Information to identify a Network Slice |
| DNN | Data Network Name where PDU connectivity |
| | service is provided |
| Application ID | Identifying the application |
| QoS Flow (1 . . . max) | List of QoS Flows |
| >Duration | Duration of QoS Flow |
| >Number of used | The number of times that this QoS Flow |
| | characteristics are used |
| >QoS profile | AN QoS profile of the QoS Flow |
| >QoS rules (1 . . . max) | UE side QoS rules of the QoS Flow |
| >>5QI | 5QI associated to the QoS Rule |
| >>QoS Parameters | QoS parameters of the QoS Rule |
| >“Service data flow | >“Service data flow detection” and “Policy |
| detection” and “Policy | control” part of PCC rules |
| control” part of PCC rules | |

The above information is presented as background information only to assist with an understanding of the present disclosure. No determination has been made, and no assertion is made, as to whether any of the above might be applicable as prior art with regard to the present disclosure.
The techniques disclosed herein are not limited to 3GPP 5G.
One or more entities in the examples disclosed herein may be replaced with one or more alternative entities performing equivalent or corresponding functions, processes or operations.
One or more of the messages in the examples disclosed herein may be replaced with one or more alternative messages, signals or other type of information carriers that communicate equivalent or corresponding information.
One or more further elements or entities may be added to the examples disclosed herein.
One or more non-essential elements or entities may be omitted in certain examples.
The functions, processes or operations of a particular entity in one example may be divided between two or more separate entities in an alternative example.
The functions, processes or operations of two or more separate entities in one example may be performed by a single entity in an alternative example.
Information carried by a particular message in one example may be carried by two or more separate messages in an alternative example.
Information carried by two or more separate messages in one example may be carried by a single message in an alternative example.
The order in which operations are performed and/or the order in which messages are transmitted may be modified, if possible, in alternative examples.

Certain examples of the present disclosure may be provided in the form of an apparatus/device/network entity configured to perform one or more defined network functions (NFs) and/or a method therefor. Certain examples of the present disclosure may be provided in the form of a system (e.g., network or wireless communication system) comprising one or more such apparatuses/devices/network entities, and/or a method therefor.

As documented in the conclusions for KI #3 in clause 8.3 of TR 23.700-84, the following conclusions for the QoS analytics were made:
The PCF may send a analytics request or subscription to NWDAF for QoS and policy assistance information analytics. The PCF may include an analytics ID, Filter Information, one or multiple sets of QoS parameters, the candidate value list(s) for each QoS parameter, requesting expected service experience (e.g., QoE), etc.
Based on the PCF request, the QoS and policy assistance information analytics provided by NWDAF may include: expected QoE can be achieved by the candidate QoS parameters (the values of the QoS parameters are within the candidate value list provided by the PCF).
The PCF may request one or more analytics from the NWDAF that are used within the same analytics target period, i.e., Observed service experience, QoS sustainability, Network Performance analytics, analytics of the duration and usage of the established QoS Flows.

Currently, in TS 23.288 Architecture enhancements for 5GS to support network data analytics services, there is no analytics related to QoS flow level analytics or the QoE of different QoS. However, to support intelligent and future-proof decision making of policy at PCF, in particular for PCC rules which is QoS flow level decision, statistics and prediction of QoS flow level parameters and the potential service experience of different QoS of will be useful.

In Solution #28 of TR 23.700-84, some information (e.g., NWDAF inputs and outputs) related to QoS flow analytics were provided, but there significant information was missing to fully specify a functional QoS flow analytics, e.g., the proposed PDU session level inputs are not sufficient for NWDAF to generate QoS flow related analytics, the proposed NWDAF outputs are limited and not effective to assist the PCF decision making.

Based on the above, to support NWDAF-assisted policy control and QoS enhancement, analytics outputs at QoS flow level and service experience of different QoS are expected to be provided by the NWDAF.

In certain examples, the NWDAF analytics (IDs) which can provide the statistics and predictions of QoS flow related parameters and the service experience of different QoS is fully specified to support NWDAF-assisted policy control and QoS enhancement for PCF.

In certain examples, the NWDAF based analytics is leveraged to provide output analytics (e.g., statistics and predictions) of QoS flow level parameters and the service experience of one or a list of QoS parameter set(s). For example, the QoS flow level output analytics may include the QoS performance parameters (e.g., data rate, latency, data volume, etc.), the usage duration and number of the usage of different QoS flows that is associated to different QoS parameter sets/profiles and the PCC rules. In addition, the service experience (e.g., MOS, QoE) of different QoS parameter sets/profiles and the PCC rules can be also provided by the NWDAF to the service consumer as required.

The consumer may request the NWDAF or subscribe to NWDAF for the QoS flow level parameters and the service experience of one or a list of QoS parameter set(s). In the request, the consumer may include some information that can help the NWDAF to derive the output and control the result reporting or update, e.g., the QoS parameter set and the potential available values of different QoS parameter set. The consumer of the QoS flow related and QoS service experience analytics could be AF, OAM, or any 5GC NF (e.g., PCF, AMF, SMF, UPF, etc.).

Based on the request of the consumer and information indicated by the consumer, the NWDAF will collect service data from multiple data sources (e.g., AF, OAM, or any 5GC NF) to perform AIML model inference and optionally model training for the required QoS flow related and QoS service experience related analytics ID. The data collected by NWDAF might be related to the performance of QoS flow and QoS parameters.

The derived output analytics can be in the form of statistics and/or predictions and will be notified to the service consumer by NWDAF. Then the consumer will take the information into account to determine or modify the policy, including the session related policy and non-session related policy.

When using PCF as an example of the service consumer, based on the PCF request, the NWDAF provides the statistics and predictions of QoS flow level parameters and the service experience of different QoS. The output analytics may include the usage frequency and usage duration of different QoS flow and the associated policy. The PCF may also require the service experience (e.g., MOS, QOE) of the different QoS and optionally at different times or during different time windows. Based on the analytics outputs and other assistance information, the PCF may determine new policy (e.g., PCC rules)/QoS or modify the existing policy (e.g., PCC rules)/QoS. For example, the PCF may choose the QoS that provides the satisfying QoE to apply within communication system and also negotiate with AF, or the PCF chooses the QoS that can achieve the highest service experience to apply within communication system.

The PCF may interact with AF to notify the determined or updated QoS for QoS negotiation and authorisation, e.g., during setting up an AF session with required QoS procedure.

By leveraging NWDAF to provide QoS flow and QoS service experience related analytics, the PCF can have better understanding of the performance and usage of different QoS flows associated to different applications and UEs. And the PCF can be aware of the service experience or the performance of different QoS parameter sets before applying the corresponding configuration into 5GS. Based on the knowledge, the PCF can choose and determine the QoS and policy, which can result in the service experience that satisfy the service requirement. Therefore, the PCF can make more intelligent, sustainable and future-proof decisions on QoS determination and modification to improve the service experience of users and overall performance of the network.

Certain examples are described in terms of a 5G core network but may also be applicable to a 4^{th} generation (4G) (evolved packet core (EPC)) or 6G core network or other future generations of communication systems.

In certain examples, the term ‘QoS’ can be replaced by policy, PCC/QoS rules, QoS policy, QoS profile, QoS parameters, QoS reference, etc.

Various examples of the present disclosure will now be described in more detail.

As described in Use Case #1 and #2 of TR 23.700-84, each PDU session is associated with a default QoS rule, which is normally sufficient for basic browsing or instant messaging over IP in general. For some services that require higher or specific QoS treatments (e.g., V2X, XRM, etc.), modification to the established PDU session may be required, e.g., by establishing new QoS flow or modifying the default QoS rule, which will increase the complex the system and involve significant system-wide signalling. Furthermore, the modification to the PDU session still cannot guarantee that the assigned QoS can satisfy the service requirements.

To optimise the network performance, the 5GC may leverage NWDAF assistance to determine the QoS and policy control in a more ‘future proof’ and multiple-service-compatible manner.

If the PCF observes that the customer service experience is low or cannot meet the requirement, the PCF may determine to update the policy (e.g., PCC rules) and inform the update policy to SMF. Then the SMF needs to derive new QoS parameters/profile and inform the information to UPF and AN. The above policy update will result in a configuration update in the entire communication system, e.g., within the core network (e.g., 5GC for 5GS and any possible terminologies for 6G and future communication systems), between core network and AN, between AN and UEs, etc.

To assist the PCF to determine policy, e.g., PCC rules, one or more analytics IDs, QoS monitoring and other measurements will be helpful, e.g., PCC rules. For example, as concluded clause 8.3 of TR 23.700-84:
The PCF may request one or more analytics from the NWDAF that are used within the same analytics target period, i.e., Observed service experience, QoS sustainability, Network Performance analytics, analytics of the duration and usage of the established QoS Flows.

Based on above, the QoS level analytics may be useful to support PCF to determine policy or support NWDAF to determine candidate QoS which will be sent to PCF for policy decision making. However, currently there is no QoS level analytics specified in TS 23.288 and the solution provided in Solution #28 in TR 23.700-84 is not sufficient, e.g., the proposed NWDAF inputs in PDU session level are not sufficient to derive the analytics output at QoS flow level, and the proposed analytics outputs are not sufficient to support the PCF to determine policy.

The QoS level analytics may be new analytics to be specified in TS 23.288, or enhancement to any existing analytics in TS 23.288, e.g., observed service experience related network data analytics, UE communication analytics, PDU session traffic analytics, etc.

In certain examples, to support NWDAF-assisted policy control and QoS enhancement, the interaction between consumer (e.g., AF, PCF) and NWDAF and the details of NWDAF analytics at QoS flow level are fully specified. The consumer requests the NWDAF to provide QoS Flow related analytics by indicating:
application ID(s).
The QoS flow/service flow associated to the interested application ID(s).
The UE(s) that are interested in the service flow from the corresponding application ID(s).
The traffic/service requirements/characteristics of the service, e.g., associated to the interested application ID(s).
   QoS requirements, QoS reference, or QoS parameters, e.g., 5QI, ARP, RQA, QoS Parameter Notification control, Flow Bit Rates, Aggregate Bit Rates, Maximum Packet Loss Rate, etc.
   Expecting/required service experience, e.g., QOE, MOS.
Potential policy (e.g., PCC rules), could be authorised or not yet authorised rules.
Indication of the request QoS flow related parameters (the QoS parameters are as defined in TS 23.501) as output, e.g., 5QI, ARP, RQA, QoS Parameter Notification control, Flow Bit Rates, Aggregate Bit Rates, Maximum Packet Loss Rate, etc.

Based on the request of the consumer and information indicated by the consumer, the NWDAF will collect service data from multiple data sources (e.g., AF, OAM, or any 5GC NF) to performance AIML model inference and optionally model training for the required QoS flow related analytics ID. Examples of the input data are described below (“Support for QoS flow analytics”).

If the NWDAF derives the output, for example, as described below (“Support for QoS service experience related analytics”), the output analytics in the form of statistics and/or predictions may be notified to the service consumer by NWDAF. Thereafter, the consumer may take the information into account to determine or modify policies, including the session related policy and non-session related policy, e.g., the PCC rules, UE policies, the AM policy, SM policy, etc.

From the perspective of the NWDAF service consumer:
If the PCF is the consumer of the QoS Flow related analytics, the PCF may determine the PCC policy based on the assistance information/analytics provided by NWDAF. For example, the PCF may determine the modify/determine the default QoS rule of a PDU session to the one that was/to be used more frequently, can satisfy the most of/all the services experience requirements (e.g., QoE) transmitted via this PDU session or QoS flow. Based on the QoS flow analytics, the PCF determines to generate new/duplicate the policy that was/to be used more frequently and can satisfy the most of/all the services experience requirements to establish new QoS flow or modified the existing QoS flow.
The AF could be also the consumer of the QoS Flow related analytics, as the AF should be aware of the QoS performance of interested UEs in interested areas to determine the expecting service quality and service requirement.
More details are described below (“6.x.4 Procedures”).

### Explanation of Time Window

In 5G NR system/5GC, multiple PDU sessions can be established for a UE. Within one PDU session, the network may determine to establish one or more QoS flow, based on network implementation. For each QoS flow, based on the description in clause 5.7.1.1 QoS Flow of TS 23.501:

Any QoS Flow is characterised by:
A QoS profile provided by the SMF to the AN via the AMF over the N2 reference point or preconfigured in the AN;
One or more QoS rule(s) and optionally QoS Flow level QoS parameters (as specified in TS 24.501 [47]) associated with these QoS rule(s) which can be provided by the SMF to the UE via the AMF over the N1 reference point and/or derived by the UE by applying Reflective QoS control; and
One or more UL and DL PDR(s) provided by the SMF to the UPF.

For a QoS flow, different PCC rules or QoS rules/parameter sets/profiles might be applied at different times (windows) to achieve the required/targeting/expected service experience and quality (e.g., QoE). The PCF/SMF may consider the traffic pattern of the UE/PDU session/QoS flow for the determination of the PCC rules/QoS rules.

For example, the PCF may configure PCC rules or QoS rules/parameter sets/profiles for a QoS flow. Thereafter, the PCF may modify the PCC rules to update the QoS rules for the UE at different time points. The PCF may further update the PCC rules or QoS rules/parameter sets/profiles in the future. The determined QoS/policy will be informed to SMF, UPF, RAN, and/or UE.

Alternatively, the PCF may configure multiple PCC rules/QoS rules for different time duration/windows of a flow. Based on the configuration, different QoS rules will be used by SMF/UPF for the flow at different time windows/durations.

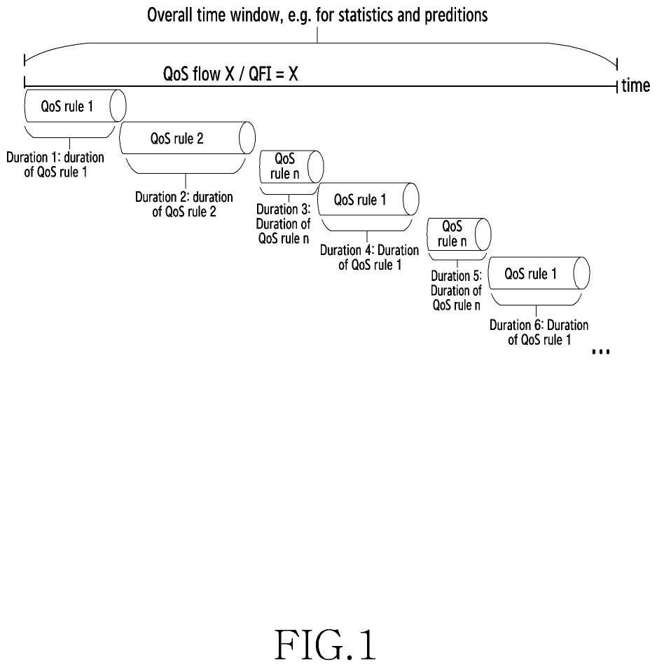

FIG. 1 illustrates an association of QoS rules/policy and applied time window according to an embodiment.

Referring to FIG. 1, for a QoS flow X (QFI=X), different QoS rules/parameters/policy may be applied at different windows based on (pre-) configuration (e.g., PDU establishment) and modification procedure (e.g., PDU modification). For example,
QoS rule ID 1 which is associated to PCC rule 1, is applied during duration/time window 1;
QoS rule ID 2 which is associated to PCC rule 2, is applied during duration/time window 2;
QoS rule ID n which is associated to PCC rule n, is applied during duration/time window 3;
It may be possible that the QoS rule ID 1, which is associated to PCC rule 1, is applied again for this QoS flow during duration/time window 4. This may be based on the configuration of the QoS rules application time, or based on the configuration modification of the QoS rules of this QoS flow (e.g., the PCF may determine that the service experience/quality of QoS/PCC rule 2 and n is not better than QoS/PCC rule 1; or due to the traffic pattern, the PCF may determine QoS/PCC rule 1 can provide better service for the in-coming traffic, etc.).
QoS rule ID n, which is associated to PCC rule n, is applied again for QoS flow X during duration/time window 5;
QoS rule ID 1, which is associated to PCC rule 1, is applied the 3^{rd} time for this QoS flow during duration/time window 6;

In certain examples, the duration/time window of QoS rules/PCC rules/QoS parameters indicates the duration 1, 2, . . . , 6, . . . , n in FIG. 1 association of QoS rules/policy and applied time window. This applies to both the inputs and outputs parameters of NWDAF.

The overall time window may be used to count to the number of usage of the QoS flow/QoS rule/QoS parameters/PCC policy. This overall time window could be configured by the service consumer in the analytics request, or preconfigured subject to operator's policy or application arrangement. The time slot entries in the output parameters maybe equivalent to the different the overall time window.

### Interaction Between NWDAF and Service Consumer (e.g., PCF, SMF, UPF, AMF, AF)

As is in clause 8.3 of TR 23.700-84 below, the PCF may require one or more analytics IDs to assist the policy determination, e.g., for PCC rules.
The PCF may request one or more analytics from the NWDAF that are used within the same analytics target period, i.e., Observed service experience, QoS sustainability, Network Performance analytics, analytics of the duration and usage of the established QoS Flows.

To require the above listed analytics IDs, the consumer (e.g., PCF, AF) may invoke the Nnwdaf_AnalyticsSubscription Service or Nnwdaf_AnalyticsInfo service operation to subscribe to NWDAF to require analytics output information from NWDAF. In addition, new pcf/nwdaf service operation might be also specified to support the policy decision making at the PCF, e.g., Nnwdaf_QoS/policy_AnalyticsSubscription Service or Nnwdaf_QoS/policy_AnalyticsInfo, etc.

More than one QoS flow usage duration and frequency/number classes may be assigned by operator/consumer/application service provider to categorise the performance and usage of QoS flows. For example, the classes are assigned to a list of UEs/QoS flow/QoS rules/QoS policy/QoS profile/application IDs/PDU sessions. The classes/groups may be classified into high, medium, and/or low usage durations and frequency/numbers with respect to the threshold(s) of the corresponding class. The threshold(s) of corresponding class might be provided by the operator/consumer/application service.

In the consumer (e.g., PCF, UPF, SMF, UDR/UDM, etc.) request or subscription to NWDAF, the following information may be included:

The bold text corresponds to certain examples of the present disclosure. The text in italic has been documented in clause 6.28.2 of TR 23.700-84.
Analytics ID, e.g. =“QoS Flow” or any other existing analytics ID(s) in TS 23.288, e.g. Observed Service Experience related network data analytics, UE communication analytics, PDU session traffic analytics, etc.
Target of Analytics Reporting: a single UE (SUPI) or a group of UEs (an Internal Group ID), any UE, a single application ID or a group of application ID(s), a or a group of PDU session application ID(s), a or a group of QoS flow ID(s) (e.g. QFI), a or a group of QoS flow ID(s) (e.g. QFI)), a or list of QoS rule identifier (QRI), etc.
Analytics Filter Information optionally including:
   S-NSSAI;
   DNN;
   Application ID;
   Area of Interest;
   an optional list of analytics subsets that are requested.
   RAT type
   type of QoS flow, e.g. GBR, non-GBR, delay-critical QoS flow.
   UE location
   one or more of the following for of a PDU session of IPv4, IPv6, IPv4v6 or Ethernet PDU session type, or unstructured PDU session type
      PDU session ID
      QoS flow ID (QFI), 5QI
      QoS parameters, QoS requirements, QoS profile, QoS rules, (PCC) policy (ID), a QoS rule identifier (QRI)—as specified in TS 24.501;
      Packet Filter Set of the QoS rule, e.g. associated to the QRI
      a precedence value of the QoS rule, e.g. associated to the QRI
      The default QoS rule indication (DQR) as specified in TS 24.501
   Service experience/QoE (Quality of experience), e.g. of the qos flow/the user(s)/the application ID/the service flow, etc.
   QoS Flow level QoS parameters (as specified in TS 24.501), e.g. for a GBR QoS flow Guaranteed flow bit rate (GFBR) for UL and DL, Maximum flow bit rate (MFBR) for UL and DL, and
   flow bit rate (UL and DL)
   delay (DL, UL and roundtrip), e.g. e2e delay between UE and UPF, delay between UE and RAN, delay between RAN and UPF, etc.
Analytics/Performance feedback information, e.g. may contain the information on the (UE) location, time (window), service quality/experience of the QoS rule, the duration and frequency/number of usage of the corresponding QoS rule(s) statistics and predictions, and the Reporting Threshold(s) that were crossed.
UE location, interested area/location
Targeting/required/expecting service experience (e.g. QoE) of a qos flow/qos rule/UE/application
A request of service experience (e.g. QoE) of a qos flow/qos rule/UE/application that was/to be achieved.
Reporting Thresholds: which apply only for subscriptions and indicate conditions on the levels to be reached for the respective analytics subsets of the analytics outputs. E.g. the thresholds of the QoS parameters, the number/usage frequency of one or more QoS flow, the duration/usage time of one or more QoS flow, QoE of one or more QoS flow/parameters/profile, etc.
type of QoS flow in the consumer's interests, e.g. GBR, non-GBR, delay-critical QoS flow.
location of UE(s)
one or more of the following for of a PDU session of IPv4, IPv6, IPv4v6 or Ethernet PDU session type, or unstructured PDU session type
   PDU session ID
   QoS flow ID (QFI), 5QI
   QoS parameters, QoS requirements, QoS profile, QoS rules, (PCC) policy (ID), a QoS rule identifier (QRI)—as specified in TS 24.501;
   Packet Filter Set of the QoS rule, e.g. associated to the QRI
   a precedence value of the QoS rule, e.g. associated to the QRI
   The default QoS rule indication (DQR) as specified in TS 24.501
Service experience/QoE (Quality of experience), e.g. of the QoS flow/the user(s)/the application ID/the service flow, etc.
QoS Flow level QoS parameters (as specified in TS 24.501), e.g. for a GBR QoS flow Guaranteed flow bit rate (GFBR) for UL and DL, Maximum flow bit rate (MFBR) for UL and DL, and
time window(s), one or more time window used to derive the statistics and prediction of the QoS flow related analytics
An Analytics target period indicates the time period over which the statistics or predictions are requested.
Preferred level of accuracy of the analytics.
Optional Preferred level of accuracy per analytics subset;
Optional preferred order of results for the list of QoS Flows:
   ordering criterion: “duration” or “number of usages”, service experience (e.g. QoE)
   order: ascending or descending. e.g. the consumer PCF/AF/SMF may require the NWDAF to provide the usage of QoS flow in descending order which means the most frequent usage QoS and/or the QoS used for the longest duration will be ranked on 1^{st} place.
Optionally, maximum number of objects. e.g. the max./min. Number of QoS flows, PDU session, max./min number of number/usage frequency of one or more QoS flow, max./min number of duration/usage time of one or more QoS flow, max./min QoE of one or more QoS flow/parameters/profile.
In a subscription, the Notification Correlation Id and the Notification Target Address are included.
different groups/classes of the Number of QoS flows, PDU session, of number/usage frequency of one or more QoS flow, of duration/usage time of one or more QoS flow, of one or more QoS flow/parameters/profile, etc. E.g. high-/medium-/low-Number of QoS flows, PDU session, of number/usage frequency of one or more QoS flow, of duration/usage time of one or more QoS flow, of one or more QoS flow/parameters/profile. The classes/groups could be configured by the operators, applications, PCF, etc.
threshold to groups the different groups/classes of Number of QoS flows, PDU session, of number/usage frequency of one or more QoS flow, of duration/usage time of one or more QoS flow, of one or more QoS flow/parameters/profile, etc.

### Support for QoS Flow Analytics

### Inputs of NWDAF

The NWDAF supporting analytics on QoS flow analytics should be able to collect information from AF, OAM, and 5GC NFs (e.g., PCF, SMF, UPF, etc.).

In Table 3 (inputs of NWDAF to derive the statistics and predictions of QoS flow related analytics), the underlined input parameters are new parameters in certain examples. The other parameters in italic have been documented in clause 6.28.2 of TR 23.700-84.

The different levels of the parameter are not limited to the examples in the table. Any parameter can be in any level, may not be necessarily in the subset of other parameters. This also applies to all the input and output parameters in the present disclosure.

TABLE 3
inputs of NWDAF to derive the statistics and predictions of QoS flow related analytics

| Information | Source | Description |
|---|---|---|
| Time | SMF | Time stamp of the generated data record |
| UE ID | SMF, AF | SUPI in the case of SMF, external UE ID |
| | | (i.e., GPSI) in the case of AF |
| Group ID | SMF, AF | To identify UE group if available. Internal |
| | | Group ID in the case of SMF, External |
| | | Group ID in the case of AF |
| S-NSSAI | SMF | Information to identify a Network Slice |
| DNN | SMF | Data Network Name where PDU |
| | | connectivity service is provided |
| Application ID | SMF, AF | Identifying the application providing this |
| | | information |
| Overall time window | SMF, UPF, | The overall time window for collecting the |
| | PCF, OAM | following data. |
| RAT Type | SMF, AMF | The RAT type the UE camps on if in idle |
| | | mode or access to if in connected mode. |
| | | If the UE is connecting to more than one |
| | | RAT type, the RAT type might be associated |
| | | to different PDU sessions or QoS (flow) |
| | | in this table. |
| PDU session ID (1 . . . max) | SMF, UPF | Identification of PDU Session. |
| >PDU Session status | SMF, | Status of the PDU Session (activated, |
| | OAM | deactivated). |
| >PDU inactivity timer/ | SMF, UPF, | Value of session inactivity timer. |
| Inactivity detection time | OAM | |
| > time stamp/point of PDU | SMF, UPF, | The time point/stamp when the PDU |
| inactivity/activity | OAM | session switches to inactivity and/or activity |
| > duration/time window | SMF, UPF, | Start and end time/time window/duration |
| | OAM | of PDU session activation/deactivation. |
| >QoS Flow ID (1 . . . max) | SMF, UPF, | Identification of QoS Flow. |
| | OAM | Max. is the max. number of the QoS flow |
| | | within the corresponding PDU session. |
| >>application ID(s)/ | SMF, UPF, | Identification of the application(s). |
| application group ID | OAM | The application(s) of which the traffic |
| | | flow(s) are associated to the corresponding |
| | | QoS flow (ID). |
| >> QFI/5QI | SMF, UPF, | Identification of QoS Flow. |
| | PCF, OAM | |
| >> QoS flow status | SMF, UPF, | For example, the QoS flow is active/not |
| | AMF, OAM | active. |
| | | Might be collected from SMF or UPF using |
| | | new events, or collects from AMF. |
| >> QoS flow active/ | SMF, UPF, | Value of QoS flow inactivity timer. |
| deactivate time | OAM | Or QoS flow activity in TS 28.552, e.g., |
| | | 5.1.1.13.2.1 In-session activity time for |
| | | QoS flow provides the aggregated active |
| | | session time for QoS flow in a cell. The |
| | | measurement is split into subcounters per |
| | | QoS level |
| >> duration/time | SMF, UPF, | Start and end time/time window/duration |
| window of QoS flow | PCF, OAM | of QoS Flow activation/deactivation. |
| status | | Or the duration/time window associated to |
| | | different QoS rules/profiles/parameters/ |
| | | policy. |
| >> flow bit rate/traffic | SMF, UPF, | flow bit rate/traffic rate of the associated |
| rate/throughput | OAM | gos flow. Might be averaged within the time |
| | | window of QoS activation and deactivation. |
| >> traffic volume | SMF, UPF, | The traffic volume of the associated qos |
| | OAM | flow. Might be accumulated within the time |
| | | window of QoS activation and deactivation. |
| >>QoS rules (1 . . . max) | | UE side QoS rules of the QoS Flow |
| >>>5QI | | 5QI associated to the QoS Rule |
| >>> QoS | SMF, UPF, | QoS parameters of the QoS Rule |
| Parameters/ | PCF | |
| QoS profile | | |
| >>> QoS rule ID | PCF, SMF, | QoS rule identifier (QRI). |
| | UPF | As defined in TS 23.501, QoS rule identifier |
| | | which is unique within the PDU Session and |
| | | is generated by SMF. |
| >>> PCC rule | PCF, AF | The PCC rule and/or the identifies of the |
| (identifies) | | PCC rules |
| >>> associated | PCF, SMF | The associated policy (e.g., PCC rule, QoS |
| policy | | related policy) corresponds to the QoS flow |
| | | and the duration/time window that the |
| | | policy rules applied. |
| >>> number of | SMF, UPF, | The number of usage of the QoS flow/QoS |
| usage | PCF | rule/QoS parameters/PCC policy. |
| | | The number of usage could be counted |
| | | within a time window, e.g., the overall time |
| | | window in FIG. 1 association of QoS |
| | | rules/policy and applied time window. |
| >>> duration/time | SMF, UPF, | The duration/time window of QoS |
| window of QoS | PCF | rules/PCC rules/QoS parameters, |
| rules/PCC rules/ | | equivalent to the duration 1, 2, . . . 6, . . . n in |
| QoS parameters | | FIG. 1 association of QoS rules/policy and |
| | | applied time window. |
| >> flow bit | SMF, UPF, | flow bit rate/traffic rate of the associated |
| rate/traffic rate/ | OAM | QoS flow per duration of QoS rules/PCC |
| throughput | | rules/QoS parameters (as defined above). |
| | | Might be averaged within the time window |
| | | of QoS activation and deactivation. |
| >>> traffic | SMF, UPF, | The traffic volume of the associated QoS |
| volume/ | OAM, AF | flow per duration of QoS rules/PCC rules/ |
| throughput | | QoS parameters (as defined above).. Might |
| | | be accumulated within the time window of |
| | | QoS activation and deactivation. |
| | | Average/Minimum/Maximum traffic |
| | | volume/Throughput. |
| >>> delay | UPF, SMF, | For example, QoS flow Packet Delay |
| | AF | collected from UPF for the observed Packet |
| | | delay for UL/DL direction. |
| | | The UE with an Application Server that |
| | | includes: UL/DL Average/Maximum |
| | | Packet Delay, |
| >>> packet loss | UPF, SMF, | UL/DL Average/Maximum Loss Rate |
| | AF, OAM | |
| UE locations (1 . . . max) and/or | AMF, AF, | UE positions |
| UE trajectory (1 . . . max) | LCS | |
| >UE location | | TA or cells that the UE enters |
| | | Location of the UE(s) needs to be collected |
| | | from AMF if the application needs to be |
| | | started at the same time. If the AoI indicated |
| | | by the AF is a finer granularity area than the |
| | | Cell level, the current location of the UE(s) |
| | | needs to be collected from GMLC instead |
| >Timestamp | | A time stamp when the AMF, AF, |
| | | LCS/GMLC detects the UE enters this |
| | | location |
| “Service data flow detection” | PCF | The information of the traffic and |
| and “Policy control” part of | | corresponding policy rules provided by the |
| PCC rules | | PCF. |

Table 4 (inputs of NWDAF collected from AF to derive the statistics and predictions of QoS flow related analytics) are new in certain examples.

The parameters listed in Table 4 (inputs of NWDAF collected from AF to derive the statistics and predictions of QoS flow related analytics) may also be collected from OAM and/or 5GC NF (e.g., PCF, SMF, UPF, UDR/UDM, etc.).

TABLE 4
inputs of NWDAF collected from AF to derive the statistics
and predictions of QoS flow related analytics

| Information | Source | Description |
|---|---|---|
| Time stamp | AF | Time stamp of the data recorded |
| Application ID | AF | AF identifier of the application |
| QoS | AF | QoS for a UE or list of UEs of the traffic from the |
| | | corresponding application ID |
| UE addresses/IDs | AF | The IDs of the UE or list of UEs, e.g., of the traffic from |
| | | the corresponding application ID |
| | | e.g., GPSI, IP address or MAC address etc. |
| Flow description | AF | as described in clause 6.1.3.6 of TS 23.503, |
| information | | e.g., source and destination IP address and port numbers |
| | | and the protocol information to enable the binding |
| | | functionality and the generation or selection of the service |
| | | data flow filter(s) in the PCC rules |
| QoS Reference or | AF | QoS Reference or individual QoS parameters associated |
| individual QoS | | to the Flow description information of the corresponding |
| parameters | | application ID |
| Alternative | AF | Containing one or more QoS Reference parameters or |
| Service | | Requested Alternative QoS Parameter Sets in a prioritized |
| Requirements | | order |
| Time period | AF | The time period associate to the parameters in this table. |
| Targeting service | AF | Targeting service quality and experience of the UE(s) of |
| quality and | | the traffic associated to the corresponding application ID |
| experience | | |
| QoS duration | AF | The duration of QoS |
| (interval) | | |
| QoS inactivity | AF | The internal of QoS inactivity or activity |
| interval | | |

### Outputs of NWDAF

The NWDAF supporting QoS flow related analytics provides the analytics results to consumer NFs, e.g., AF, PCF, SMF, UPF, or NEF. The analytics results provided by the NWDAF could be QoS flow statistics and/or predictions.

In Table 5 (QoS flow related statistics and predictions), the underlined output parameters are new parameters in examples of the present disclosure. The other Italic parameters have been documented in clause 6.28.2 of TR 23.700-84.

TABLE 5
QoS flow related statistics and predictions

| Information | Description |
|---|---|
| UE ID | SUPI in the case of SMF, external UE |
| | ID (i.e., GPSI) in the case of AF |
| | Could be one or list of UEs. |
| S-NSSAI | Information to identify a Network Slice |
| DNN | Data Network Name where PDU |
| | connectivity service is provided |
| Application ID | Identifying the application |
| RAT type(s) | Indicate the list of RAT types, e.g., for |
| | which the UE(s)/PDU session/QoS |
| | flow. e.g., LTE, NR, 6G RAN, etc. |
| | The RAT type the UE camps on if in |
| | idle mode or access to if in connected |
| | mode. |
| | If the UE is connecting to more than |
| | one RAT type, the RAT type might be |
| | associated to different PDU sessions or |
| | QoS (flow) in this table. |
| Time slot entry (1 . . . max) | Time slot entry (1 . . . max) |
| > PDU session (1 . . . max) | The PDU session of the UE(s) |
| >> PDU session ID | The ID of the corresponding PDU |
| | session |
| >> QoS Flow ID (1 . . . max) | List of QoS Flows within a PDU |
| | session |
| | The max. is the maximum number of |
| | the QoS, e.g., within the corresponding |
| | PDU session |
| >>> QoS flow ID/QFI | Identification of QoS Flow |
| >>>Duration/Time window | The statistics and predictions of |
| | Duration/time window of QoS Flow/ |
| | start and end time associated to the QoS |
| | flow activation/deactivation. |
| >>>Number of usages | The number of times that this QoS Flow |
| | characteristics are used |
| >>> Application ID(s)/application | The application ID(s) associated to the |
| group ID | corresponding QoS flow/policy/QoS |
| | profile/QoS parameters. |
| >>>QoS profile | AN QoS profile of the QoS Flow |
| >>>QoS rules (1 . . . max) | UE side QoS rules of the QoS Flow |
| >>>>5QI | 5QI associated to the QoS Rule |
| >>>>QoS Parameters | QoS parameters of the QoS Rule |
| >>>> QoS rule identifier | QoS rule identifier (QRI), as specified |
| (QRI); | in TS24.501. |
| >>>> PCC rule identifies | The identifier of the PCC rule |
| >>>> QoE, service quality/ | QoE, service quality/experience |
| experience | Associated to the corresponding QoS |
| | flow and the duration |
| >>>> applied level of QoS | How often the QoS is used. |
| flow/QoS profile/QoS | The applied frequency/level of the |
| parameter/policy | corresponding QoS flow/QoS profile/ |
| | QoS parameter/policy, e.g., High-, |
| | medium-, low- frequency/level of the |
| | corresponding QoS flow/QoS profile/ |
| | QoS parameter/policy applied/used for |
| | data/service transmission. |
| >>>> QoS duration | The duration of the QoS applied. For |
| | example, start and end time associated |
| | to the QoS rule/parameters/policy |
| >>>> service experience | The service experience of QoS, e.g., |
| | QoE. |
| >>> flow bit rate | Bit rate of the QoS Flow, for GBR |
| | flow. |
| | Could be GFBR - UL and DL, and/or |
| | MFBR -- UL and DL. |
| >>> QoS flow type | The type of QoS flow, e.g., GBR, non- |
| | GBR, delay-critical QoS flow. |
| > Validity period | The validity period for the QoS flow |
| | related statistics and prediction as |
| | defined in clause 6.1.3 of TS 23.288. |
| > spatial Validity | The Area where the QoS flow related |
| | statistics and prediction applied. |
| classified usage level of QoS flow | Classified usage level of QoS flow |
| | statistics and predictions for multiple |
| | UEs/QoS flows/PDU session with |
| | respect to one or more reporting |
| | thresholds (e.g., NWDAF may provide |
| | the ratio of QoS floes that have reached |
| | certain Reporting Threshold(s)). |
| | The list of UEs/QoS flows or the |
| | associated application ID is indicated |
| | in the request of service consumer. |
| > usage level of QoS flow classes (1 . . . max) | List with group of UEs/QoS |
| | flows/policies/QoS classified by ranges |
| | of usage level of QoS flow, e.g., the |
| | number of usage, the usage frequency, |
| | duration, etc. |
| | The QoS flow might be replaced by the |
| | PCC rule/policy (ID), QoS parameters, |
| | QoS profile (ID), etc. |
| | The QoS flow classes could be high-, |
| | medium, low-frequency usage/number |
| | of usage; or long-, medium-, short- |
| | duration of usage. |
| >> UE ID(s)/QoS flow IDs/PCC rule/ | Identifies the UE(s)/QoS flow/PCC |
| policy (ID), QoS parameters, QoS profile | rule/policy/PDU session, or QoS |
| (ID)/PDU session | parameters, QoS profile in the class |
| | with respect to the threshold of the |
| | corresponding usage frequency or |
| | duration. |
| >> Ratio usage level of QoS flow classes | Ratio of UEs of QoS parameters/QoS |
| | profile (ID/policy/QoS flow per class. |
| > Validity period | The validity period for the QoS flow |
| | related statistics and prediction as |
| | defined in clause 6.1.3 of TS 23.288. |
| > spatial Validity | The Area where the QoS flow related |
| | statistics and prediction applied. |
| >“Service data flow detection” and “Policy | Traffic description and applied PCC |
| control” part of PCC rules | rules |

### Support for QoS Service Experience Related Analytics

### 6.x.1 General

Clause 6.x describes how NWDAF can provide the QoE of candidate QoS based on the consumer request.

QoS and policy assistance analytics can be used to assist PCF with deciding policy, i.e., PCC rules and QoS parameters. The consumer may provide the list of targeting QoS and PCC rules of a service flow to the NWDAF. Based on the targeting QoS parameter set(s) provided by the consumer, the NWDAF generates the QoE(s) of the corresponding QoS parameter set(s) in the list.

In addition, the service consumer may also provide the allowed values of individual QoS parameters of the different QoS parameter set(s) in the list, and the targeting service experience (i.e., QoE) of the service flow. Using the list of targeting QoS and the allowed values of individual QoS parameters, the NWDAF generates the candidate QoS parameter set(s) that can fulfil the QoE indicated by the service consumer and informs the consumer of the candidate QoS parameter set(s), the PCC rules and the associated QoE(s).

To derive the QoS analytics, the NWDAF collects data from AF, OAM, and 5GC NFs (e.g., SMF, PCF, etc.). The consumer can either subscribe to analytics notifications (i.e., a Subscribe-Notify model) or request a single notification (i.e., a Request-Response model).

The consumer may provide a list of target QoS parameter sets and optionally list(s) of candidate values of individual QoS parameters of different QoS parameter sets, e.g., list of candidate values of UL/DL flow bit rate of QoS parameter set 1, a list of candidate values Maximum Packet Loss Rate of QoS parameter set 2, etc. The consumer may also provide the expecting QoE(s) associated to the list of QoS parameter set(s) and optionally the acceptable range/variation of the expecting QoE(s) (e.g., X<QoE <Y), the minimum/maximum/average acceptable QoE.

Based on the request of the consumer, the NWDAF generates the QoE of the target QoS parameter set(s) provided by the consumer. If the consumer also provides the candidate values of individual QoS parameters in different QoS parameter set(s), the NWDAF may optimise the QoS parameter set(s) by computing the QoE of different QoS parameter combinations.

The NWDAF may also notify the QoS parameter set(s) that can satisfy the QoE requirements to the consumer, and optionally in the order as required by the consumer (e.g., ascending or descending order to the QoE). If there is no QoS parameter set/combination that can satisfy the required QoE, the NWDAF may notify the one or more QoS parameter set/combinations with the best QoE, e.g., the QoS parameter set/combinations associated to top N QoE/service experience quality.

The service consumer may be an NF (e.g., PCF or AF).

The consumer of these analytics indicates in the request or subscription:
Analytics ID=“QoS and policy assistance analytics”.
Target of Analytics Reporting as defined in clause 6.1.3.
Analytics Filter Information optionally includes:
   DNN;
   Application ID;
   Area of interest (AOI(s)): restricts the scope of the QoS service experience analytics to the provided area;
   -A list of analytics subsets that are requested (see clause 6.x.3), e.g., QoS requirements (e.g., 5QI, QoE of different QoS).
A list of target QoS parameter set(s) and the associated PCC rule identifier, and optional the candidate values of one or more individual QoS parameters in the QoS parameter set(s).
The expecting QoE/MOS associated to each targeting QoS parameter set(s), including the lowest/minimum/maximum/variance/average service experience level/quality/QoE/MOS, the range of the acceptable QoE/MOS (e.g., N<MOS <M). The NWDAF may only notify the consumer of the QoS parameter set that can satisfy the service quality requirement. The expecting QoE/MOS associated to each targeting QoS parameter set(s) could be also the reporting threshold of this analytics ID.
An Analytics target period indicates the time period over which the statistics or predictions are requested.
In a subscription, the Notification Correlation Id and the Notification Target Address are included.
Optionally, preferred level of accuracy of the analytics.
Optionally, preferred level of accuracy per analytics subset (see clause 6.x.3).
Optionally, preferred order of results for the list of QoE associated to QoS:
   ordering criterion: “QoE associated to QoS”,
   order: ascending or descending.
Optionally, Reporting Thresholds, which apply only for subscriptions and indicate conditions on the levels to be reached for the respective analytics subsets (see clause 6.x.3).

### 6.x.2 Input Data

The NWDAF supporting analytics on candidate QoS shall be able to collect information from AF, OAM and 5GC NFs.

The input data collect from AF defined for Observed Service Experience related network data analytics in Table 6.4.2-1 is reused. In addition to the data in Table 6.4.2-1 and Table 6.4.2-la, other information collected by the NWDAF from the AF is defined in the Table 6.x.2-1.

The information collected by the NWDAF from relevant 5GC NFs (i.e., UPF, SMF, AMF, PCF) is defined in Table 6.x.2-2.

The input data collected from OAM for E2E data volume transfer time analytics in Table 6.18.2-1 can be reused.

TABLE 6.x.2-1
Input data from AF related to QoS and policy assistance analytics

| Information | Source | Description |
|---|---|---|
| Application ID | AF | Identifier of the application at the AF. |
| UE ID | AF | The list of UE IDs that are associated to the |
| | | service flows/candidate QoS with the Service |
| | | Experience value(s). |
| | | When the AF is untrusted, GPSIs will be |
| | | provided. When the AF is trusted SUPIs will |
| | | be provided. |
| QoS reference | AF | The (pre-defined) QoS information of the |
| | | service flow associated to the application ID |
| | | to present the service requirement of the AF. |
| QoS parameters | AF | Individual QoS parameters of the flow |
| | | associated to the application ID to present the |
| | | service requirement of the AF, i.e., Requested |
| | | Priority, Maximum Burst Size, Requested |
| | | 5GS Delay, Requested Maximum Bitrate, |
| | | Requested Guaranteed Bitrate and Requested |
| | | Packet Error Rate. |
| Time window | AF | The time window to apply the QoS |
| | | parameters. |
| Alternative service | AF | Indicate a list of preference of the QoS |
| requirements | | parameters sets in prioritized order with |
| | | which the service can operate. |
| | | Each Requested Alternative QoS Parameter |
| | | Set is comprised of the following individual |
| | | parameters: Requested 5GS Delay, Requested |
| | | Guaranteed Flow Bitrate and Requested |
| | | Packet Error Rate. Each requested Alternative |
| | | QoS Parameter Set may also include a |
| | | Maximum Burst Size parameter, as described |
| | | in clause 6.1.3.22 of TS 23.503). |
| Expecting service experience | AF | The expecting or required service experience |
| | | (e.g., MOS, QoE) of the service flow |
| | | associated to the application ID. |
| Averaging Window | AF | The value of the averaging window for |
| | | deriving individual QoS parameters for GBR |
| | | QoS Flows. |

TABLE 6.x.2-2
Input data from 5GC NF related to QoS and policy assistance analytics

| Information | Source | Description |
|---|---|---|
| PCC rule/QoS policy | PCF | The content of PCC rule/QoS policy, as |
| | | defined in Table 6.3.1 of TS 23.503. |
| PCC rule identifier | PCF | The identifier of the PCC rule. |
| QoS parameter set(s) | PCF, SMF, | The QoS parameter set(s) deployed into 5GS. |
| | PCF | The QoS parameter set(s) including |
| | | individual QoS parameters and QoS |
| | | characteristics as defined in TS 23.501. |
| | | e.g., 5QI, ARP/Priority Level, RQA, |
| | | Alternative QoS Profiles/parameters, Flow |
| | | Bit Rates, GFBR, MFBR, Aggregate Bit |
| | | Rates, Session-AMBR, UE-AMBR, UE- |
| | | Slice-MBR, Default values, Packet Loss Rate, |
| | | Resource type/QoS flow type, PDB, Packet |
| | | Error Rate |
| | | Averaging Window, Maximum Data Burst |
| | | Volume |
| | | Packet Filter Set, PDU Set QoS Parameters, |
| | | etc. |
| QoS profile ID | SMF, UPF | The identifier of the QoS profile associated to |
| | | the QoS flow/PCC rule. |
| QoS profile | SMF, UPF | The QoS profile associated to the QoS flow/ |
| | | PCC rule. |
| 5QI | PCF, SMF, | The 5QI/reference of the QoS parameters and |
| | UPF | QoS characteristics. Could be standardised |
| | | and non-standardised 5QIs. |
| Active duration of QoS | PCF, SMF, | The active/applicable duration of the QoS/ |
| | UPF | policy. |
| PDU session ID | SMF, UPF | PDU session ID |
| PDU Session Type | SMF, UPF | The type of the PDU session, i.e., Ethernet |
| | | PDU Session Type and IP PDU Session Type. |
| Default values | PCF, SMF, | The default values of QoS parameters of the |
| | UDM | PDU session. |
| QFI | SMF, UPF | The QFI associated to the PCC rule/QoS |
| | | parameter set/profile. |
| Time stamp | PCF, SMF, | The time stamp associated to the collected |
| | UPF | data. |
| Averaging time window | PCF, SMF, | The averaging window used to measure the |
| | UPF | parameters, e.g., data rate, data volume. |
| | | The averaging window might be a |
| | | standardized value. |
| Start time and end time | UPF | Start time and end time of the measurement. |
| UE location | AMF, | The location of the corresponding UE, e.g., |
| | GMLC, | TA or cells that the UE enters, the location in |
| | LCS | a finer granularity than cell level. |
| Service data of QoS related | SMF, UPF, | Service data of QoS related parameters and |
| parameters and | PCF, OAM | characteristics, e.g., real time measurement |
| characteristics | | (based on QoS monitoring), |
| > Congestion information | | The UL and/or DL QoS Flow congestion |
| | | information. |
| > jitter information | | The N6 jitter information for UL/DL |
| | | collected from UPF. |
| > Data rate/flow bit rate | | UL and/or DL data rate per QoS flow/UE at |
| | | the PSA UPF and it can be applied to a Non- |
| | | GBR or GBR QoS flow. |
| | | Could be data rate between UE and RAN, UE |
| | | and UPF, UPF and RAN. |
| > Traffic delay | | For example, QoS flow Packet Delay for |
| | | UL/DL/Round trip collected from UPF, delay |
| | | between UE and RAN, UE and UPF, UPF and |
| | | RAN collected from OAM. |
| > data volume/throughput | | Measured UL/DL/overall data traffic volume/ |
| | | throughput for the flow of the UE. |
| > packet loss rate | | The Maximum/average Packet Loss Rate of |
| | | UL and/or DL. |

TABLE 6.x.2-3
Input data from OAM related to QoS and policy assistance analytics, same as Table
6.18.2-1: Input data from OAM related to E2E data volume transfer time in TS 23.288

| Information | Source | Description |
|---|---|---|
| RAN part delay for DL and | OAM | Average packet transmission delay through |
| UL | (See | the RAN part to the UE per 5QI and per S- |
| | NOTE 2) | NSSAI as specified in clauses 6.3.1.2.1 and |
| | | 6.3.1.7.1 of TS 28.554 and per UE level per |
| | | supported S-NSSAI and per QoS level in |
| | | clauses 6.3.1.1.1 and 6.3.1.1.6 of TS 28.558. |
| Timestamp | OAM | A time stamp associated with the collected |
| | | information. |
| RAN Throughput for DL and | OAM | The per UE measurement of the throughput |
| UL | (see | for DL and UL as specified in clauses 5.2.1.1 |
| | NOTE 1) | and 5.4.1.1 of TS 37.320. |
| RAN Packet delay for DL | OAM | The per UE measurement of the packet delay |
| and UL | (see | for DL and UL, including per DRB per UE |
| | NOTE 1) | packet delay as specified in clause 5.4.1.1 of |
| | | TS 37.320. |
| RAN Packet loss rate for DL | OAM | The per UE measurement of the packet loss |
| and UL | (see | rate for DL and UL, including per DRB per |
| | NOTE 1, | UE packet loss rate as specified in |
| | NOTE 2) | clause 5.4.1.1 of TS 37.320 and packet loss |
| | | rate per UE per QoS level and per supported |
| | | S-NSSAI in clauses 6.3.1.2.1 and 6.3.1.3.1 of |
| | | TS 28.558. |
| Average UL/DL packet delay | OAM | The average of UL/DL packet delay between |
| between PSA UPF and UE | (See | PSA UPF and UE per S-NSSAI as specified in |
| | NOTE 2) | clauses 5.4.9.1.1 and 5.4.9.2.1 of |
| | | TS 28.552 and per UE level per supported S- |
| | | NSSAI and per QoS level in clauses 6.2.2.1.1 |
| | | and 6.2.2.1.3 of TS 28.558. |
| Average UL/DL Packet delay | OAM | The per UE level per supported S-NSSAI and |
| between PSA UPF and RAN | (See | per QoS level of the average UL/DL packet |
| | NOTE 2) | delay between PSA UPF and RAN as |
| | | specified in clauses 6.2.2.1.4 and 6.2.2.1.5 of |
| | | TS 28.558. |
| Average DL/UL UE | OAM | Average DL/UL UE throughput in the gNB |
| throughput in gNB | (See | per QoS level (mapped 5QI) and per S-NSSAI |
| | NOTE 2) | as specified in clauses 5.1.1.3.1 and 5.1.1.3.3 |
| | | of TS 28.552 and per UE per supported S- |
| | | NSSAI and per QoS level clauses 6.3.1.4.1 |
| | | and 6.3.1.4.2 of TS 28.558. |

NOTE 1:
Per UE measurement for a specific UE from OAM (via MDT), is as specified in clause 6.2.3.1 in TS 37.230.
NOTE 2:
In addition to the average KPIs, per UE level measurements if available, can be taken into account by the NWDAF.

### 6.x.3 Output Analytics

The NWDAF supporting analytics on candidate QoS provides the analytics results to consumer NFs, e.g., PCF or AF. The analytics results provided by the NWDAF could be candidate QoS statistics as defined in Table 6.x.3-1 or predictions as defined in table 6.x.3-2.

TABLE 6.x.3-1
Service experience associated of candidate QoS

| Information | Description |
|---|---|
| UE ID or list of UE IDs | Identifies the UE(s)for which the statistic applies by a list of |
| (1 . . . SUPImax) | SUPIs. |
| Time slot entry (1 . . . max) | List of time slots during the Analytics target period. |
| > Time slot start | Time slot start within the Analytics target period. |
| > Duration | Duration of the time slot. |
| > Service experience | Service experience information of a list of candidate QoS, e.g., |
| information of | The service experience of user(s)/UEs. |
| candidate QoS | The list of candidate QoS is indicated in the consumer request. |
| (1 . . . max) (NOTE 1) | Max. is the number of the QoS parameter set(s), if applicable. |
| >> DNN | DNN for the PDU Session which contains the QoS flow. |
| >> S-NSSAI | Identifies the Network Slice used to access the application. |
| >> RAT Type | Indicate the list of RAT types for which the Service experience |
| | information of candidate QoS applies. |
| >> Access Type | Access Type when the UE establishes a PDU Session for the AF. |
| >> UE location | Indicate the UE location information when the service is |
| | delivered. |
| >> PDU session ID | The PDU session of the QoS flow associated to the PCC |
| | rule/QoS parameters belongs to. |
| >> PDU Session Type | The type of the PDU session, i.e., Ethernet PDU Session Type |
| | and IP PDU Session Type. |
| >> QFI | The QoS flow that associated to the PCC rule/QoS parameters. |
| >> Application ID(s) | Identifies the application(s) that associated to the PCC rule or |
| | QoS. |
| >> Access Type | Access Type when the UE establishes a PDU Session for the |
| | AF(s). |
| >> PCC rule identifier | The identifier of the PCC rule associated to the QoS parameters. |
| >> QoS service | The service experience (e.g., QoE, MOS) of the corresponding |
| experience | QoS parameter set (e.g., average, peak, maximum, minimum, |
| | variance). |
| >> QoS service | The variation/variance of the QoS service experience (e.g., QoE, |
| experience variation | MOS) within the time window or time slot. |
| | If the variation/variance of the |
| >> valid duration of | The time window or time slot/duration that is associated to the |
| QoS service experience | QoS service experience. |
| >> data volume | The UL/DL/overall data volume of the QoS flow within the valid |
| | duration. |
| >> candidate QoS | The values of one or more individual QoS parameters within the |
| parameters and | QoS parameter set. |
| characteristics | |
| >>> 5QI | The reference to 5G QoS characteristics/parameter sets. |
| >>> ARP/Priority | The QoS parameter ARP contains information about the priority |
| Level | level, the pre-emption capability and the pre-emption |
| | vulnerability, as defined in TS 23.501. |
| >>> RQA (NOTE 4) | RQA only applies to Reflective QoS. |
| | The RQA is an optional parameter which indicates that certain |
| | traffic (not necessarily all) carried on this QoS Flow is subject to |
| | Reflective QoS, as defined in TS 23.501. |
| >>> Notification | |
| control | |
| >>> Alternative QoS | The alternative QoS Profiles/parameters of the QoS flow. |
| Profiles/parameters | |
| >>> Flow Bit Rates | The flow bit rates only apply to GBR QoS Flow. |
| (NOTE 2) | |
| >>>> GFBR | GFBR for UL and/or DL. |
| >>>> MFBR | MFBR for UL and/or DL. |
| >>> Aggregate Bit | The aggregate bit rate of PDU session, UE, or slice. |
| Rates (NOTE 2) | |
| >>>> Session-AMBR | The aggregate bit rate limit of the corresponding PDU Session of |
| | the UE. |
| >>>> UE-AMBR | The aggregate bit rate limit of the corresponding UE. |
| >>>> UE-Slice-MBR | The aggregate bit rate limit of each group of PDU Sessions of |
| | the UE for the same slice (S-NSSAI). |
| >>> Default values | Optimised default QoS parameters for PDU session |
| | establishment or modification. |
| >>> Packet Loss Rate | The Maximum Packet Loss Rate (UL, DL) indicates the |
| (NOTE 2) | maximum rate for lost packets of the QoS Flow that can be |
| | tolerated in the UL and DL direction. This is provided to the QoS |
| | Flow if it is compliant to the GFBR |
| >>> Resource type/ | The resource type of the corresponding QoS flow, e.g., GBR |
| QoS flow type | QoS flow, non-GBR QoS flow, delay-critical QoS flow. |
| >>> PDB | PDB indicates the upper bound for the time that a packet may be |
| | delayed between the UE and the N6 termination point at the UPF, |
| | as defined in TS 23.501. |
| >>> Packet Error Rate | Packet Error Rate (PER) defines an upper bound for a rate of |
| | non-congestion related packet losses, as defined in TS 23.501. |
| >>> Averaging | The Averaging window is applied when the resource type is |
| Window (NOTE 2) | GBR QoS. |
| | The Averaging window represents the duration over which the |
| | GFBR and MFBR shall be calculated (e.g., in the (R)AN, UPF, |
| | UE), as defined in TS 23.501. |
| >>> Maximum Data | The Maximum Data Burst Volume (MDBV)applies to GBR QoS |
| Burst Volume | Flow with Delay-critical resource type. |
| (NOTE 3) | The MDBV denotes the largest amount of data that the 5G-AN |
| | is required to serve within a period of 5G-AN PDB, as defined |
| | in TS 23.501. |
| >>> Packet Filter Set | The Packet Filter Set is used in the QoS rule and the PDR to |
| | identify one or more packet (IP or Ethernet) flow(s), including |
| | IP Packet Filter Set (as defined in clause 5.7.6.2 of TS 23.501) |
| | and Ethernet Packet Filter Set (as defined in clause 5.7.6.3 of |
| | TS 23.501). |
| >>>> PDU Set QoS | As defined in clause 5.7.7 of TS 23.501, the PDU Set QoS |
| Parameters | Parameters are used to support PDU Set based QoS handling in |
| | the NG-RAN, including PDU Set Delay Budget (PSDB), PDU |
| | Set Error Rate (PSER), PDU Set Integrated Handling |
| | Information (PSIHI). |
| >> Validity period | The validity period within the time slot for the xxxxx statistics |
| | as defined in clause 6.1.3. |
| >> Spatial validity | Area where the xxxx statistics applies. |

(NOTE 1):
Analytics subset that can be used in “list of analytics subsets that are requested”, “Preferred level of accuracy per analytics subset” and “Reporting Thresholds”.
(NOTE 2):
The output analytics only applies to GBR QoS Flow.
(NOTE 3):
The output analytics only applies to GBR QoS Flow with Delay-critical resource type.
(NOTE 4):
The output analytics only applies to Reflective QoS.

### 6.x.4 Procedures

The NWDAF may provide the analytics of QoS and policy assistance analytics to a consumer 5GC NF (e.g., PCF).

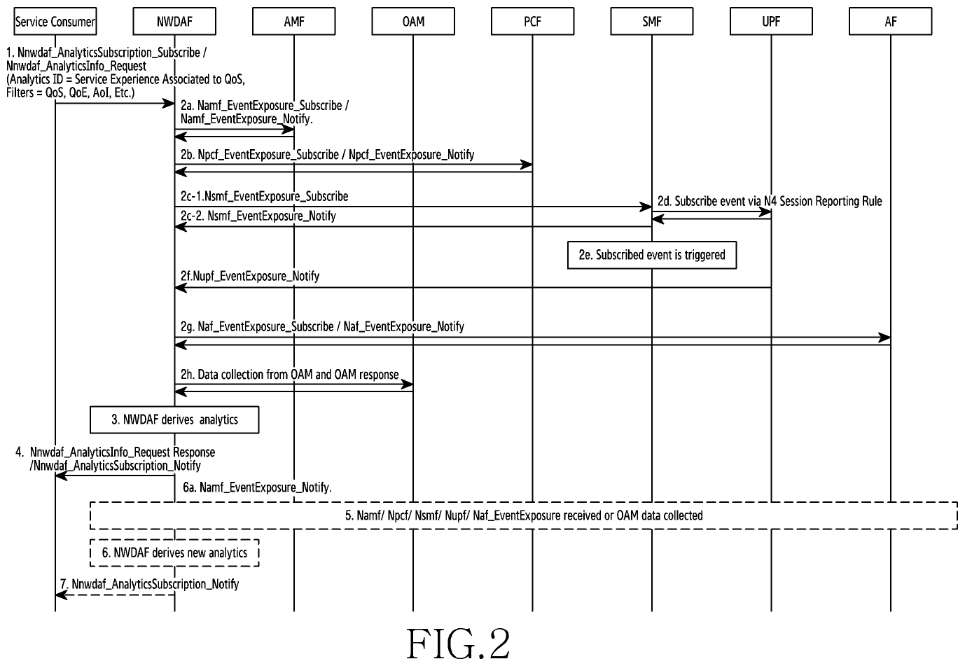

FIG. 2 illustrates a procedure for candidate QoS analytics according to an embodiment.

Referring to FIG. 2:
1. The Consumer NF, e.g., PCF or AF, requests or subscribes to analytics for QoS and policy assistance analytics from NWDAF (possibly via NEF in case the consumer NF is an untrusted AF) and provides the input information as specified in clause 6.x.1 to 5GC.
2a. The NWDAF may subscribe to the service data from AMF as defined in Table 6.x.2-2 using Namf_EventExposure_Subscribe service operation for collecting UE location(s) for a UE or a group of UEs.
NOTE: If NWDAF requires UE location information with finer granularity than TA/cell level, then NWDAF collects the location data from GMLC instead of AMF.
2b. The NWDAF may subscribe to service data from PCF as defined in Table 6.x.2-2 by invoking Npcf_EventExposure_Subscribe service operation (Event ID, PCC rule ID, SUPI(s) or Application ID).
2c-1. The NWDAF may subscribe to service data from SMF as defined in Table 6.x.2-2 by invoking Nsmf_EventExposure_Subscribe service operation (Event ID, QoS profile ID, PCC rule ID, SUPI(s) or Application ID).
2d. To provide the QoS flow Packet delay to NWDAF the SMF subscribe to QoS Monitoring information from UPF, as defined in Table 6.x.2-2, using the N4 Session level Reporting procedure defined in TS 23.502.
2e. The subscribed event is triggered in the UPF.
2c-2. The SMF notifies the NWDAF of the subscribed service data.
2f. Alternatively, the UPF may notify the subscribed event report directly to the NWDAF.
2g. The NWDAF may subscribe to the service data from as defined AF in the Table 6.x-2-1 by invoking Nnef_EventExposure_Subscribe or Naf_EventExposure_Subscribe (Event ID=QoS and policy assistance analytics, Application ID, Event Filter information, Target of Event Reporting=UE ID(s)) service as defined in TS 23.502.
2 h. The NWDAF may subscribe to the input data from the OAM as defined in the Table 6.18.2-1 according to the data collection principles described in clause 6.2.3.
3. The NWDAF derives the requested analytics on QoS and policy assistance analytics.
4. The NWDAF provides the requested QoS and policy assistance analytics to the consumer NF, using either Nnwdaf_AnalyticsInfo_Request response or Nnwdaf_AnalyticsSubscription_Notify, depending on the service used in step 1.
5-7. If the consumer NF subscribed to QoS and policy assistance analytics in step 1, once the NWDAF generates new analytics for QoS and policy assistance analytics, it provides a notification using Nnwdaf_AnalyticsSubscription_Notify to the Consumer NF.

### Consumer Behaviours of Using the QoS Flow and QoS Service Experience Related Analytics

### If PCF is the Consumer of NWDAF Analytics

When the PCF is used as an example of the consumer: based on the QoS flow related analytics, the PCF is aware of the usage information of different policies/QoS/QoS flows, and optionally the service experience of the users or applications. Then the PCF may take different actions to enhance the user experience by modifying the QoS/policy configuration:
The PCF may determine to release/optimise the QoS policy (and any related parameters and configurations) that are used less frequently and result in low service experience/quality, to save resources and optimise the network performance.
The PCF may determine to steer traffic of some services from the less frequently used and low service experience QoS to the better QoS flows and modify the policy/PCC rules of the corresponding services/flows.
The PCF may modify the QoS/PCC rules of the less frequently used and low service experience QoS flows to improve service experience.
The PCF may establish new/modify QoS flows by deploying the QoS/PCC rules that are in higher ranking, e.g., used more frequently and with higher service experience.
The PCF may determine the modify/determine the default QoS rule of a PDU session to the one that was/to be used more frequently, can satisfy the most of/all the services experience requirements (e.g., QoE) transmitted via this PDU session or QoS flow.
The PCF determines to generate new/duplicate the policy that was/to be used more frequently and can satisfy the most of/all the services experience requirements to establish new QoS flow or modified the existing QoS flow.

The classified usage classes of QoS can help the PCF to understand the applied frequency/level of the corresponding QoS, e.g., High-, medium-, low-usage frequency or duration of the corresponding QoS flow/QoS profile/QoS parameters/policy (e.g., PCC rule) for the service flows (e.g., for data/service transmission for UE or application). Alternatively, the ranking of the QoS (e.g., QoS flow/QoS profile/QoS parameter/policy etc.) can be provided to the PCF implicitly or explicitly.
The NWDAF may include the ranking in the output analytics, e.g., the ranking is from 1 to the max. Number of QoS flows/policies/QoS profiles/parameters. Rank 1 means this QoS flow/QoS profile/QoS parameter/policy is the most frequent used and/or longest duration of the QoS, rank max. means the least frequent used one and/or the shortest duration, or another way around.
Or the consumer may indicate the preferred order of results for the list of QoS (Flows). Then the NWDAF will provide the outputs in the order as required by the consumer. See above under the heading “Interaction between NWDAF and service consumer”.

Validity period and spatial validity of the QoS flow related Statistics and prediction should be provided by NWDAF. The PCF may require multiple analytics IDs to assist the policy determination or modification. Those analytics should be valid for the same Validity period and Spatial validity or the Validity period and Spatial validity should overlap. The policy determined by the PCF by taking the analytics IDs into account will be valid during the (overlapped) Validity period and in the area of (overlapped) spatial validity of multiple analytics IDs. The analytics IDs may include:
QoS flow related analytics
UE communication analytics
QoS Sustainability analytics
Observed Service experience analytics

The PCF may interact with SMF and then UPF to notify the determined or updated QoS to apply the QoS within the communication system. The corresponding QoS and policy enforcement will be also performed based on the determined or updated QoS. The determined or updated QoS will be also delivered to based station and UE for traffic transmission.

### If the AF is the Consumer of the QoS Flow Analytics:

Based on the output analytics, the AF is aware of the statistics and the prediction of performance of different QoS flow. Therefore, the AF will take the QoS flow performance information into account to generate more reasonable service requirements on the communication system. As the result, the AF service requirements (e.g., expecting QoE, qos parameters) will be more likely to be authorised by the PCF. Accordingly, the AF services may be transmitted via the communication system in a more service quality guaranteed manner.

The accompanying annex to this description (“Change Request”) discloses example modifications to the existing 3GPP standard to incorporate one or more of the techniques described herein.

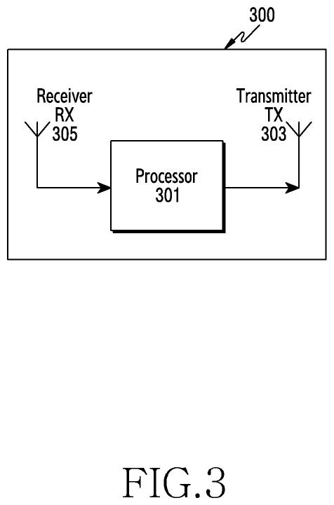

FIG. 3 illustrates a network entity according to an embodiment.

Referring to FIG. 3, for example, a UE/network entity (e.g., PCF, AMF, SMF, NWDAF)/BS (e.g., eNB, gNB) in the examples of FIGS. 1 and 2 may include an entity of FIG. 3. The skilled person will appreciate that a network entity 300 may be implemented, e.g., as a network element on a dedicated hardware, as a software instance running on a dedicated hardware, and/or as a virtualised function instantiated on an appropriate platform, e.g., on a cloud infrastructure.

The network entity 300 includes a processor (or controller) 301, a transmitter 303, and a receiver 305. The receiver 305 is configured for receiving one or more messages from one or more other network entities, for example as described above. The transmitter 303 is configured for transmitting one or more messages to one or more other network entities, for example as described above. The processor 301 is configured for performing one or more operations, for example according to the operations as described above.

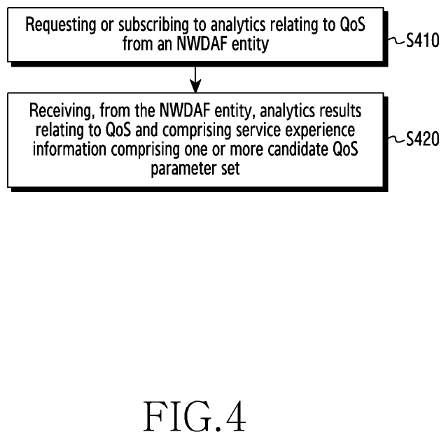

FIG. 4 is a flow diagram illustrating a method of a PCF entity according to an embodiment. Specifically, FIG. 4 illustrates a method of a PCF entity.

Referring to FIG. 4, in step S410, the PCF entity requests or subscribes to analytics relating to QoS from an NWDAF entity. The request or subscription indicates one or more QoS parameter set. Each QoS parameter set includes at least one parameter and, for each of the at least one parameter, a value for the parameter. The at least one parameter includes at least one of a 5QI, one or more QoS characteristics, a GFBR, or an MFBR.

In step S420, the PCF entity receives, from the NWDAF entity, analytics results relating to QoS and comprising service experience information comprising one or more candidate QoS parameter set.

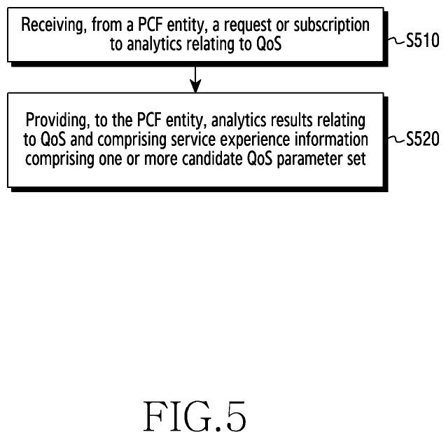

FIG. 5 is a flow diagram illustrating a method of an NWDAF entity according an embodiment.

Referring to FIG. 5, in operation S510, the NWDAF entity receives, from a PCF entity, a request or subscription to analytics relating to QoS from an NWDAF entity. The request or subscription indicates one or more QoS parameter set. Each QoS parameter set includes at least one parameter and, for each of the at least one parameter, a value for the parameter. The at least one parameter includes at least one of a 5QI, one or more QoS characteristics, a GFBR, or an MFBR.

In step S520, the NWDAF entity provides, to the PCF entity, analytics results relating to QoS and comprising service experience information comprising one or more candidate QoS parameter set.

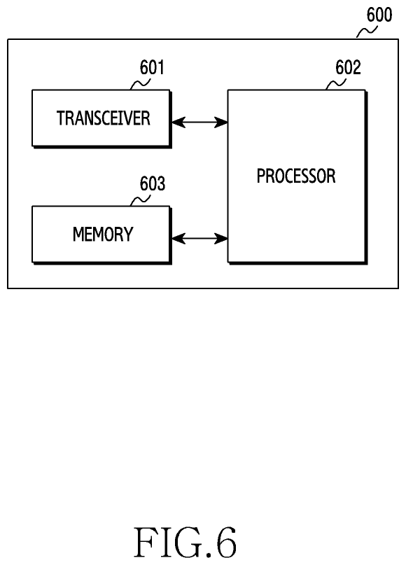

FIG. 6 illustrates a terminal or UE according to an embodiment.

Referring to FIG. 6, the terminal 600 is an electronic device capable of wireless communication, may include a UE, a portable phone, a smartphone, a tablet, an Internet of things (IoT) device, etc., having various form factors, and may perform wireless communication with a BS through a wireless channel.

Referring to FIG. 6, the UE 600 may include at least one transceiver (hereinafter, referred to as simply “transceiver”) 601, at least one processor (hereinafter, referred to as simply “processor”) 602, and at least one memory (hereinafter, referred to as simply “memory”) 603. According to at least one or a combination of methods corresponding to the embodiments described in the present disclosure, the transceiver 601, the processor 602, and the memory 603 of the UE 600 may operate. However, components of the UE 600 are not limited to the exemplary components illustrated in FIG. 6. In another embodiment, the UE 600 may further include additional components in addition to the above-mentioned components, or some components may be omitted. Further, in some embodiments, any combination of the transceiver 601, the processor 602, or the memory 603 may be integrated in the form of one component.

The transceiver 601 may be a communication circuit or communication circuitry that enables the UE 600 to perform wireless communication with a node or an entity of a network. For example, the transceiver 601 may enable the UE 600 to transmit or receive a signal to or from a BS through cellular communication, or to transmit or receive a signal to or from another UE through cellular communication. For example, the transceiver 601 may support at least one of various cellular communication technologies including 3rd generation (3G), 4G, long term evolution (LTE), 5G NR, 6G, and various cellular wireless communication technologies supported by the transceiver 601 may include all subsequent generations of evolved wireless communications.

According to an embodiment, the UE 600 may include a plurality of transceivers. For example, in the case of supporting evolved-universal terrestrial radio access-new radio (E-UTRA-NR) dual connectivity (EN-DC), the UE 600 may include a first transceiver supporting the 4G LTE wireless communication and a second transceiver supporting the 5G NR wireless communication. According to another embodiment, in the case of supporting NR-dual connectivity (NR-DC), the UE 600 may include a plurality of transceivers supporting the 5G NR wireless communication. According to still another embodiment, in the case of supporting near field wireless communication, the UE 600 may separately include a transceiver supporting at least one standard in the group of wireless communication protocol standards as defined in the protocol standards for Bluetooth®, wireless local area network (WLAN) network (including institute of electrical and electronics engineers (IEEE) 802.11-2016 standard or its amendments, e.g., 802.11ah, 802.11ad, 802.11ay, 802.11ax, 802.11az, 802.11ba, and 802.11be, without being limited thereto).

According to an embodiment, the transceiver 601 may include various circuit structures used to transmit or receive signals to or from a BS through a wireless channel. The signals may include control information and data. For example, the transceiver 601 may include a radio frequency (RF) transmitter for up-converting and amplifying the frequency of a transmitted signal and an RF receiver for low-noise-amplifying a received signal and down-converting the frequency thereof. The transceiver 601 may output a signal received through a wireless channel to the processor 602 and may transmit, through a wireless channel, a signal output from the processor 602.

The processor 602 may control general operations of the UE 600 according to embodiments of the disclosure. The processor 602 may be implemented by one or more IC chips and may execute various data processings. The processor 602 may include at least one electric circuit, and may execute instructions (or a program, codes, data, etc.) stored in the memory 603, individually, collectively or in any combination thereof. Further, the processor 602 may include a single-core processor or multi-core processor, and may include a processor assembly including a plurality of processing circuits (circuitry) according to a specific implementation scheme.

The processor 602 may be electrically, operatively, or communicatively coupled to the transceiver 601 to control the transceiver 601.

The processor 602 may include at least one processor (or processing circuitry), and the at least one processor may perform the following operations individually, collectively or in any combination thereof. For example, the processor 602 may include a CP configured to control communication operations and an AP configured to control execution of an upper layer (for example, an application layer). In a specific embodiment, at least a part of the processor 602 may be included in one chip and the other part of the processor 602 may be included in another chip. Otherwise, at least one processor may be included in another component, for example, the transceiver 601 or the memory 603.

The processor 602 may perform or control or cause an operation of the UE 600 for executing at least one or a combination of methods according to embodiments of the disclosure. For example, the processor 602 may control operations of the UE 600 for processing a DL signal received from a BS or generating and transmitting a UL signal to a BS. To this end, the processor 602 may execute a computer program, codes, or instructions stored in the memory 603, so as to control other components of the UE 600 to enable execution of various operations.

The memory 603 corresponds to a hardware storage device capable of temporarily or permanently storing information and may include one or more storage media. For example, the memory 603 may include a memory assembly including one or more storage media. For example, the one or more storage media may include permanent memory, such as a hard drive, flash memory, or ROM, semipermanent memory, such as RAM, cache memory, or a combination thereof.

The memory 603 may be electrically, operatively, or communicatively coupled to the processor 602 and may be accessed by the processor 602.

The memory 603 may store a computer program, codes, or instructions executable by the processor 602. According to an embodiment, a computer program, codes, or instructions executable by the processor 602 may be either stored in a single memory device or separated and distributedly stored in two or more memory devices. By executing the instructions stored in the memory 603, the processor 602 may perform various functions according to an embodiment of the disclosure.

According to an embodiment of the disclosure, operations of the UE 600 may be caused to be performed based on execution of instructions (or a computer program or codes) stored in the memory 603 by at least one processor (or processing circuitry) configured to execute the same individually, collectively, or in any combination thereof, based on processing circuitry that is not configured to execute instructions, and/or based on components of processing circuitry that is not configured to execute instructions.

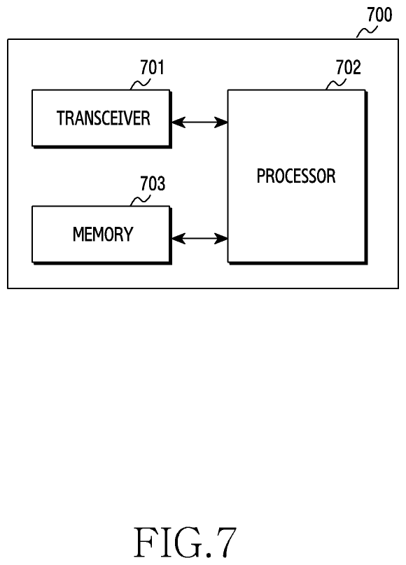

FIG. 7 illustrates a BS according to an embodiment.

The BS 700 may perform wireless communication with at least one user equipment (UE) located within the area of the BS 700 through a wireless channel.

Referring to FIG. 7, the BS 700 may include at least one transceiver (hereinafter, referred to as simply “transceiver”) 701, at least one processor (hereinafter, referred to as simply “processor”) 702, and at least one memory (hereinafter, referred to as simply “memory”) 703. According to at least one or a combination of methods corresponding to the embodiments described in the present disclosure, the transceiver 701, the processor 702, and the memory 703 of the BS 700 may operate. However, components of the BS 700 are not limited to the exemplary components illustrated in FIG. 7. In another embodiment, the BS 700 may further include additional components in addition to the above-mentioned components, or some components may be omitted. Further, in some embodiments, any combination of the transceiver 701, the processor 702, or the memory 703 may be integrated in the form of one component.

The transceiver 701 may be a communication circuit or communication circuitry that enables the BS 700 to perform wireless communication with a node or an entity of a network. For example, the transceiver 701 may enable the BS 700 to transmit or receive a signal to or from the UE 600 through cellular communication, or to transmit or receive a signal to or from another network entity through wireless communication. For example, the transceiver 701 may support various cellular communication technologies including 3G, 4G, LTE, 5G NR, or 6G, and various cellular wireless communication technologies supported by the transceiver 701 may include all subsequent generations of evolved wireless communications.

According to an embodiment, the transceiver 701 may include various circuit structures used to transmit or receive signals to or from a UE through a wireless channel. The signals may include control information and data. For example, the transceiver 701 may include an RF transmitter for up-converting and amplifying the frequency of a transmitted signal and an RF receiver for low-noise-amplifying a received signal and down-converting the frequency thereof. The transceiver 701 may output a signal received through a wireless channel to the processor 702 and may transmit, through a wireless channel, a signal output from the processor 702.

Meanwhile, according to an embodiment of the present disclosure, the BS 700 may perform communication with a node or an entity of a network through wired or wireless communication. For example, the BS 700 may perform wired or wireless communication with an adjacent BS, or a node or an entity of a core network through a backhaul network. Although not illustrated in FIG. 7, when the BS 700 performs wired communication, the BS 700 may further include a separate network interface for wired communication in addition to the transceiver 701. The network interface may be referred to as network interface circuitry or communication interface circuitry.

The processor 702 may control general operations of the BS 700 according to embodiments of the disclosure. The processor 702 may be implemented by one or more IC chips and may execute various data processings. The processor 702 may include at least one electric circuit, and may execute instructions (or a program, codes, data, etc.) stored in the memory 703, individually, collectively or in any combination thereof. Further, the processor 702 may include a single-core processor or multi-core processor, and may include a processor assembly including a plurality of processing circuits (circuitry) according to a specific implementation scheme.

The processor 702 may be electrically, operatively, or communicatively coupled to the transceiver 701 to control the transceiver 701.

The processor 702 may include at least one processor (or processing circuitry), and the at least one processor may perform the following operations individually, collectively or in any combination thereof. In a specific embodiment, at least a part of the processor 702 may be included in one chip and the other part of the processor 702 may be included in another chip. Otherwise, at least one processor may be included in another component, for example, the transceiver 701 or the memory 703.

The processor 702 may perform or control or cause an operation of the BS 700 for executing at least one or a combination of methods according to embodiments of the disclosure. For example, the processor 702 may control operations of the BS 700 for generating and transmitting a DL signal to a UE or processing a UL signal received from a UE. Otherwise, the BS 700 may transmit or receive a signal to or from a neighboring BS, transfer a signal received from a UE to an upper node of the network, or transmit a signal transferred from an upper node of the network to a UE. To this end, the processor 702 may execute a computer program, codes, or instructions stored in the memory 703, so as to control other components of the BS 700 to enable execution of various operations.

The memory 703 corresponds to a hardware storage device capable of temporarily or permanently storing information and may include one or more storage media. For example, the memory 703 may include a memory assembly including one or more storage media. For example, the one or more storage media may include permanent memory, such as a hard drive, flash memory, or ROM, semipermanent memory, such as RAM, cache memory, or a combination thereof.

The memory 703 may be electrically, operatively, or communicatively coupled to the processor 702 and may be accessed by the processor 702.

The memory 703 may store a computer program, codes, or instructions executable by the processor 702. According to an embodiment, a computer program, codes, or instructions executable by the processor 702 may be either stored in a single memory device or separated and distributedly stored in two or more memory devices. By executing the instructions stored in the memory 703, the processor 702 may perform various functions according to an embodiment of the disclosure.

According to an embodiment of the disclosure, operations of the BS 700 may be caused to be performed based on execution of instructions (or a computer program or codes) stored in the memory 703 by at least one processor (or processing circuitry) configured to execute the same individually, collectively, or in any combination thereof, based on processing circuitry that is not configured to execute instructions, and/or based on components of processing circuitry that is not configured to execute instructions.

The UE or the BS may perform various communication procedures related to the control plane or the user plane by cooperating with one or more network entities based on wireless communication. For example, the UE may communicate with network entity such as an AMF or an SMF via the BS, or the BS may perform at least one communication procedure by directly transmitting and receiving signals to/from, or relaying signals between, the network entities.

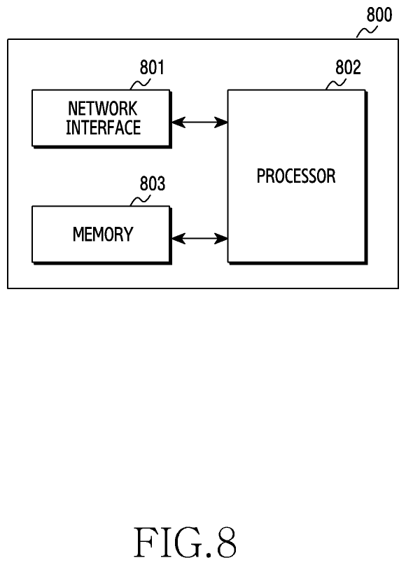

FIG. 8 illustrates a network entity according to an embodiment.

Referring to FIG. 8, the network entity 800 includes an entity (apparatus, device, server, etc.) that performs one or more NFs or a part of an NF constituting a core network (e.g., a 5G core (5GC)) in a communication system. In this case, multiple NFs may be implemented within a single network entity, or a single NF may be distributed and implemented across a plurality of network entities. In addition, when an NF is implemented within the network entity, the NF may be implemented in the form of software, and in such a case, a program for operating the NF may be stored in memory of the network entity 800.

A single NF may be implemented by one or more instances, which may be deployed on the same network entity or distributed across multiple network entities to operate. The instance may be a software unit that logically executes a specific NF, and may be implemented in a form that is decoupled from physical hardware resources. Further, one or more NFs may be implemented in the form of one network slice to operate to satisfy specifications required by a particular service.

The NF may include at least one of an AMF, an SMF, a local SMF (L-SMF), a UPF, a local UPF (L-UPF), a PCF, a UDM, a UDR, an NEF, a network repository function (NRF), an AF, a network slice selection function (NSSF), an NWDAF, a network slice admission control function (NSACF), an authentication server function (AUSF), or a data network (DN).

Referring to FIG. 8, the network entity 800 may include at least one network interface 801, at least one processor 802 (hereinafter, “processor”), and at least one memory 803 (hereinafter, “memory”). As described above, a NF may be implemented in the form of a physical device such as the network entity 800, or may be virtualized and executed in the form of an instance. When implemented as an instance, the NF need not necessarily include physical components as illustrated in FIG. 8. In such a case, the instance may be logically represented as comprising one or more logical functional elements.

According to at least one or a combination of methods corresponding to the embodiments described in the present disclosure, the network interface 801, the processor 802, and the memory 803 of the network entity 800 may operate. However, components of the network entity 800 are not limited to the exemplary components illustrated in FIG. 8. In another embodiment, the network entity 800 may further include additional components in addition to the above-mentioned components, or some components may be omitted. Further, in an embodiment, the network interface 801, the processor 802, or the memory 803 may be integrated in the form of one component.

The network interface 801 is a collective term for a transmitter part of the network entity 800 and a receiver part of the network entity 800, and may be a communication circuit for transmitting or receiving a signal to or from a UE, a BS, or another network entity. Here, the communication circuit may include both a communication circuit for wireless communication and a communication circuit for a wired communication. For example, the network interface 801 may include a circuit, logic, hardware, etc., configured to exchange a control plane message or a user plane message with a UE, a BS, or other core network entities through wireless communication or wired communication. The network interface 801 may operate using various protocols (e.g., NAS protocol). The network interface 801 may also be referred to, for convenience of description or depending on implementation, as communication circuitry, network interface circuitry, or a communication interface circuitry.

The processor 802 may control general operations of the network entity 800 according to embodiments of the disclosure. The processor 802 may be implemented by one or more IC chips and may execute various data processings. The processor 802 may include at least one electric circuit, and may execute instructions (or a program, codes, data, etc.) stored in the memory 803, individually, collectively or in any combination thereof. Further, the processor 802 may include a single-core processor or multi-core processor, and may include a processor assembly including a plurality of processing circuits (circuitry) according to a specific implementation scheme. Further, it should be noted that, according to another embodiment, in a case where NF is implemented in the form of an instance, the network function may be not necessarily configured by physical hardware.

According to an embodiment, the processor 802 may be electrically, operatively, or communicatively coupled to the network interface 801 to control the network interface 801.

The processor 802 may include at least one processor (or processing circuitry), and the at least one processor may perform the following operations individually, collectively or in any combination thereof. In a specific embodiment, at least a part of the processor 802 may be included in one chip and the other part of the processor 802 may be included in another chip. Otherwise, at least one processor may be included in another component, for example, the network interface 801 or the memory 803.

The processor 802 may perform or control or cause an operation of the network entity 800 for executing at least one or a combination of methods according to embodiments of the disclosure. For example, the processor 802 may control operations of the network entity 800 for exchanging a control plane message or a user plane message with a UE, a BS, or other core network entities through wireless or wired communication, using various protocols (e.g., NAS protocol). To this end, the processor 802 may execute a computer program, codes, or instructions stored in the memory 803, so as to control other components of the network entity 800 to enable execution of various operations.

The memory 803 corresponds to a hardware storage device capable of temporarily or permanently storing information and may include one or more storage media. For example, the memory 803 may include a memory assembly including one or more storage media. For example, the one or more storage media may include permanent memory, such as a hard drive, flash memory, or ROM, semipermanent memory, such as RAM, cache memory, or a combination thereof.

The memory 803 may be electrically, operatively, or communicatively coupled to the processor 802 and may be accessed by the processor 802.

The memory 803 may store a computer program, codes, or instructions executable by the processor 802. According to an embodiment, a computer program, codes, or instructions executable by the processor 802 may be either stored in a single memory device or separated and distributedly stored in two or more memory devices. By executing the instructions stored in the memory 803, the processor 802 may perform various functions according to an embodiment of the disclosure.

According to an embodiment of the disclosure, operations of the network entity 800 may be caused to be performed based on execution of instructions (or a computer program or codes) stored in the memory 803 by at least one processor (or processing circuitry) configured to execute the same individually, collectively, or in any combination thereof, based on processing circuitry that is not configured to execute instructions, and/or based on components of processing circuitry that is not configured to execute instructions.

Meanwhile, although specific embodiments of the present disclosure have been described in detail, various modifications may be made without departing from the scope of the present disclosure. Therefore, the scope of the present disclosure should not be limited to the described embodiments, but should be defined by the claims and equivalents thereof.

What is claimed is:

1. A method performed by a network data analytics function (NWDAF) entity in a wireless communication system, the method comprising:
receiving, from a policy control function (PCF) entity, a first message requesting analytics of quality of service (QoS) and policy assistance, wherein the first message includes at least one QoS parameter set; and
transmitting, to the PCF entity, a second message including the analytics,
wherein the analytics include predictions on the QoS and policy assistance associated with the at least one QoS parameter set, and
wherein QoS parameters or a policy to apply for a service are based on the analytics.

2. The method of claim 1, further comprising obtaining input data including first information on an uplink (UL) delay or a downlink (DL) delay from an operations, administration, and maintenance (OAM) entity, and second information related to the QoS and policy assistance,
wherein the second information includes at least one of information on a packet filter set from a session management function (SMF) entity, or information on a packet loss rate from a user plane function (UPF) entity, and
wherein the analytics are based on the input data.

3. The method of claim 1, wherein the first message further includes a requested quality of experience (QoE) indicating that the QoS parameters are equal to or higher than the requested QoE.

4. The method of claim 1, wherein each of the at least one QoS parameter set includes at least one of a 5G QoS identifier (5QI), QoS characteristics, or a bit rate including a guaranteed bit rate (GBR) and a maximum bit rate (MBR).

5. The method of claim 1, wherein the predictions include at least one candidate QoS parameter set and a corresponding predicted QoE, and
wherein the at least one candidate QoS parameter set and the corresponding predicted QoE are within the QoS parameters.

6. A method performed by a policy control function (PCF) entity in a wireless communication system, the method comprising:
transmitting, to a network data analytics function (NWDAF) entity, a first message requesting analytics of quality of service (QoS) and policy assistance, wherein the first message includes at least one QoS parameter set;
receiving, from the NWDAF entity, a second message including the analytics, wherein the analytics include predictions on the QoS and policy assistance associated with the at least one QoS parameter set; and
identifying QoS parameters or a policy to apply for a service based on the analytics.

7. The method of claim 6, wherein the analytics are based on an input data,
wherein the input data includes first information on an uplink (UL) delay or a downlink (DL) delay from an operations, administration, and maintenance (OAM) entity, and second information related to the QoS and policy assistance, and
wherein the second information includes at least one of information on a packet filter set from a session management function (SMF) entity, or information on a packet loss rate from a user plane function (UPF) entity.

8. The method of claim 6, wherein the first message further includes a requested quality of experience (QoE) indicating that the QoS parameters are equal to or higher than the requested QoE.

9. The method of claim 6, wherein each of the at least one QoS parameter set includes at least one of a 5G QoS identifier (5QI), QoS characteristics, or a bit rate including a guaranteed bit rate (GBR) and a maximum bit rate (MBR).

10. The method of claim 6, wherein the predictions include at least one candidate QoS parameter set and a corresponding predicted QoE, and
wherein the at least one candidate QoS parameter set and the corresponding predicted QoE are within the QoS parameters.

11. A network data analytics function (NWDAF) entity comprising:
at least one processor; and
at least one memory, communicatively coupled to the at least one processor, storing instructions executable by the at least one processor individually or in any combination to cause the NWDAF entity to:
receive, from a policy control function (PCF) entity, a first message requesting analytics of quality of service (QoS) and policy assistance, wherein the first message includes at least one QoS parameter set, and
transmit, to the PCF entity, a second message including the analytics,
wherein the analytics includes predictions on the QoS and policy assistance associated with the at least one QoS parameter set, and
wherein QoS parameters or a policy to apply for a service are based on the analytics.

12. The NWDAF entity of claim 11, wherein the instructions further cause the NWDAF entity to:
obtain input data including first information on an uplink (UL) delay or a downlink (DL) delay from an operations, administration, and maintenance (OAM) entity, and second information related to the QoS and policy assistance,
wherein the second information includes at least one of information on a packet filter set from a session management function (SMF) entity, or information on a packet loss rate from a user plane function (UPF) entity, and
wherein the analytics are based on the input data.

13. The NWDAF entity of claim 11, wherein the first message further includes a requested quality of experience (QoE) indicating that the QoS parameters are equal to or higher than the requested QoE.

14. The NWDAF entity of claim 11, wherein each of the at least one QoS parameter set includes at least one of a 5G QoS identifier (5QI), QoS characteristics, or a bit rate including a guaranteed bit rate (GBR) and a maximum bit rate (MBR).

15. The NWDAF entity of claim 11, wherein the predictions include at least one candidate QoS parameter set and a corresponding predicted QoE, and
wherein the at least one candidate QoS parameter set and the corresponding predicted QoE are within the QoS parameters.

16. A policy control function (PCF) entity comprising:
at least one processor; and
at least one memory, communicatively coupled to the at least one processor, storing instructions executable by the at least one processor individually or in any combination to cause the PCF entity to:
transmit, to a network data analytics function (NWDAF) entity, a first message requesting analytics of quality of service (QoS) and policy assistance, wherein the first message includes at least one QoS parameter set,
receive, from the NWDAF entity, a second message including the analytics including predictions on the QoS and policy assistance associated with the at least one QoS parameter set, and
identify QoS parameters or a policy to apply for a service based on the analytics.

17. The PCF entity of claim 16, wherein the analytics are based on an input data,
wherein the input data includes first information on an uplink (UL) delay or a downlink (DL) delay from an operations, administration, and maintenance (OAM) entity, and second information related to the QoS and policy assistance, and
wherein the second information includes at least one of information on a packet filter set from a session management function (SMF) entity, or information on a packet loss rate from a user plane function (UPF) entity.

18. The PCF entity of claim 16, wherein the first message further includes a requested quality of experience (QoE) indicating that the QoS parameters are equal to or higher than the requested QoE.

19. The PCF entity of claim 16, wherein each of the at least one QoS parameter set includes at least one of a 5G QoS identifier (5QI), QoS characteristics, or a bit rate including a guaranteed bit rate (GBR) and a maximum bit rate (MBR).

20. The PCF entity of claim 16, wherein the predictions include at least one candidate QoS parameter set and a corresponding predicted QoE, and
wherein the at least one candidate QoS parameter set and the corresponding predicted QoE are within the QoS parameters.
